(19) United States
(12) Patent Application Publication
(10) Pub. No.: US 2021/0081477 A1
(43) Pub. Date: Mar. 18, 2021

(54) FILTERING SIGNALS DURING MAJOR EVENTS

(71) Applicant: safeXai, Inc., Sandy, UT (US)

(72) Inventors: Colby Tibbet, Salt Lake City, UT (US); Joshua J. Newman, Park City, UT (US)

(21) Appl. No.: 17/016,679

(22) Filed: Sep. 10, 2020

Related U.S. Application Data
(63) Continuation-in-part of application No. 17/008,557, filed on Aug. 31, 2020.
(60) Provisional application No. 62/900,177, filed on Sep. 13, 2019.
(60) Provisional application No. 62/929,430, filed on Nov. 1, 2019.

(51) Int. Cl. G06F 16/9536; G06F 16/9537; G06F 16/29; G06F 16/2458

(52) U.S. Cl. CPC G06F 16/9536; G06F 16/9537; G06F 2216/03; G06F 16/2465; G06F 16/29

(57) ABSTRACT

The present invention extends to methods, systems, and computer program products for filtering signals during major events. A major event is detected in a geographic area based on one or more of: signal volume, signal diversity, severity, content, or historical events associated with ingested digital signals corresponding to the geographic area. An event-specific filter is deployed. The region associated with the major event is locked to the geographic area. Filtering out a commentary signal purportedly related to the major event is filtered out in accordance with rejection criteria. Filtering out the commentary signal can include determining the commentary signal originated outside the geographic area. It is determined that the major event has ended. The event-specific filter is disabled.

### CROSS-REFERENCE TO RELATED APPLICATIONS

This application is a continuation in part of U.S. patent application Ser. No. 17/008,557, entitled “Detecting Major Events”, filed Aug. 31, 2020, which is incorporated herein in its entirety.

This application claims the benefit of U.S. Provisional Patent Application Ser. No. 62/900,177, entitled “Region Lock”, filed Sep. 13, 2019, which is incorporated herein in its entirety.

This application claims the benefit of U.S. Provisional Patent Application Ser. No. 62/929,430, entitled “Major Events And Region Lock”, filed Nov. 1, 2019, which is incorporated herein in its entirety.

### BACKGROUND

### 1. Background and Relevant Art

Entities (e.g., parents, guardians, friends, relatives, teachers, social workers, first responders, hospitals, delivery services, media outlets, government entities, etc.) may desire to be made aware of relevant events (e.g., fires, accidents, police presence, shootings, power outage, etc.) as close as possible to the events' occurrence. However, entities typically are not made aware of an event until after a person observes the event (or the event aftermath) and calls authorities.

In general, techniques that attempt to automate event detection are unreliable. Some techniques have attempted to mine social media data to detect the planning of events and forecast when events might occur. However, events can occur without prior planning and/or may not be detectable using social media data. Further, these techniques are not capable of meaningfully processing available data nor are these techniques capable of differentiating false data (e.g., hoax social media posts)

Other techniques use textual comparisons to compare textual content (e.g., keywords) in a data stream to event templates in a database. If text in a data stream matches keywords in an event template, the data stream is labeled as indicating an event.

Additional techniques use event specific sensors to detect specified types of event. For example, earthquake detectors can be used to detect earthquakes.

### BRIEF SUMMARY

Examples extend to methods, systems, and computer program products for filtering signals during major events.

A major event is detected in a geographic area based on one or more of: signal volume, signal diversity, severity, content, or historical events associated with ingested digital signals corresponding to the geographic area. An event-specific filter is deployed. The region associated with the major event is locked to the geographic area.

Filtering out a commentary signal purportedly related to the major event is filtered out in accordance with rejection criteria. Filtering out the commentary signal can include determining the commentary signal originated outside the geographic area. It is determined that the major event has ended. The event-specific filter is disabled.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1A illustrates an example computer architecture that facilitates normalizing ingesting signals.

FIG. 1B illustrates an example computer architecture that facilitates detecting events from normalized signals.

FIG. 2 illustrates a flow chart of an example method for normalizing ingested signals.

FIGS. 3A, 3B, and 3C illustrate other example components that can be included in signal ingestion modules.

FIG. 4 illustrates a flow chart of an example method for normalizing an ingested signal including time information, location information, and context information.

FIG. 5 illustrates a flow chart of an example method for normalizing an ingested signal including time information and location information.

FIG. 6 illustrates a flow chart of an example method for normalizing an ingested signal including time information.

FIG. 7 illustrates an example computer architecture that facilitates detecting an event from features derived from multiple signals.

FIG. 8 illustrates a flow chart of an example method for detecting an event from features derived from multiple signals.

FIG. 9 illustrates an example computer architecture that facilitates detecting an event from features derived from multiple signals.

FIG. 10 illustrates a flow chart of an example method for detecting an event from features derived from multiple signals

FIG. 11A illustrates an example computer architecture that facilitates forming a signal sequence.

FIG. 11B illustrates an example computer architecture that facilitates detecting an event from features of a signal sequence.

FIG. 11C illustrates an example computer architecture that facilitates detecting an event from features of a signal sequence.

FIG. 11D illustrates an example computer architecture that facilitates detecting an event from a multisource probability.

FIG. 11E illustrates an example computer architecture that facilitates detecting an event from a multisource probability.

FIG. 12 illustrates a flow chart of an example method for forming a signal sequence.

FIG. 13 illustrates a flow of an example method for detecting an event from a signal sequence.

FIG. 14 illustrates an example three-dimensional heat map representation of a geo cell database portion.

FIG. 15 illustrates a computer architecture that facilitates splitting signal sequences.

FIG. 16 illustrates a flow chart of an example method for splitting a signal sequence.

FIG. 17 illustrates a computer architecture that facilitates identifying major events.

FIG. 18 illustrates a flow chart of an example method for detecting human ripple effect.

FIG. 19 illustrates a computer architecture that facilitates filtering signals during major events.

FIG. 20 illustrates a flow chart of an example method for filtering signals during major events.

FIG. 21 illustrates a view of an example locked region and corresponding commentary zone.

### DETAILED DESCRIPTION

Examples extend to methods, systems, and computer program products for filtering signals during events.

Entities (e.g., parents, other family members, guardians, friends, teachers, social workers, first responders, hospitals, delivery services, media outlets, government entities, etc.) may desire to be made aware of relevant events as close as possible to the events' occurrence (i.e., as close as possible to “moment zero”). Different types of ingested signals (e.g., social media signals, web signals, and streaming signals) can be used to detect events.

In general, signal ingestion modules ingest different types of raw structured and/or raw unstructured signals on an ongoing basis. Different types of signals can include different data media types and different data formats. Data media types can include audio, video, image, and text. Different formats can include text in XML, text in JavaScript Object Notation (JSON), text in RSS feed, plain text, video stream in Dynamic Adaptive Streaming over HTTP (DASH), video stream in HTTP Live Streaming (HLS), video stream in Real-Time Messaging Protocol (RTMP), other Multipurpose Internet Mail Extensions (MIME) types, etc. Handling different types and formats of data introduces inefficiencies into subsequent event detection processes, including when determining if different signals relate to the same event.

The signal ingestion modules can normalize raw signals across multiple data dimensions to form normalized signals (e.g., in a common format). Each dimension can be a scalar value or a vector of values. In one aspect, raw signals are normalized into normalized signals having a Time, Location, Context (or “TLC”) dimensions (or into a TLC format). As such, per signal type, signal ingestion modules identify and/or infer a time, a location, and a context associated with a signal. Different ingestion modules can be utilized/tailored to identify time, location, and context for different signal types.

A Time (T) dimension can include a time of origin or alternatively a “event time” of a signal. A Location (L) dimension can include a location anywhere across a geographic area, such as, a country (e.g., the United States), a State, a defined area, an impacted area, an area defined by a geo cell, an address, etc.

A Context (C) dimension indicates circumstances surrounding formation/origination of a raw signal in terms that facilitate understanding and assessment of the raw signal. The Context (C) dimension of a raw signal can be derived from express as well as inferred signal features of the raw signal.

Signal ingestion modules can include one or more single source classifiers. A single source classifier can compute a single source probability for a raw signal from features of the raw signal. A single source probability can reflect a mathematical probability or approximation of a mathematical probability (e.g., a percentage between 0%-100%) of an event actually occurring. A single source classifier can be configured to compute a single source probability for a single event type or to compute a single source probability for each of a plurality of different event types. A single source classifier can compute a single source probability using artificial intelligence, machine learning, neural networks, logic, heuristics, etc.

As such, single source probabilities and corresponding probability details can represent a Context (C) dimension. Probability details can indicate (e.g., can include a hash field indicating) a probability version and (express and/or inferred) signal features considered in a signal source probability calculation.

Thus, per signal type, signal ingestion modules determine Time (T), a Location (L), and a Context (C) dimensions associated with a signal. Different ingestion modules can be utilized/tailored to determine T, L, and C dimensions associated with different signal types. Normalized (or “TLC”) signals can be forwarded to an event detection infrastructure. When signals are normalized across common dimensions subsequent event detection is more efficient and more effective.

Normalization of ingestion signals can include dimensionality reduction. Generally, “transdimensionality” transformations can be structured and defined in a “TLC” dimensional model. Signal ingestion modules can apply the “transdimensionality” transformations to generic source data in raw signals to re-encode the source data into normalized data having lower dimensionality. Thus, each normalized signal can include a T vector, an L vector, and a C vector. At lower dimensionality, the complexity of measuring “distances” between dimensional vectors across different normalized signals is reduced.

Concurrently with signal ingestion, the event detection infrastructure considers features of different combinations of normalized signals to attempt to identify events of interest to various parties. Features can be derived from an individual signal and/or from a group of signals.

For example, the event detection infrastructure can derive first features of a first normalized signal and can derive second features of a second normalized signal. Individual signal features can include: signal type, signal source, signal content, signal time (T), signal location (L), signal context (C), other circumstances of signal creation, etc. The event detection infrastructure can detect an event of interest to one or more parties from the first features and the second features collectively.

Alternately, the event detection infrastructure can derive first features of each normalized signal included in a first one or more normalized individual signals. The event detection infrastructure can detect a possible event of interest to one or more parties from the first features. The event detection infrastructure can derive second features of each normalized signal included in a second one or more individual signals. The event detection infrastructure can validate the possible event of interest as an actual event of interest to the one or more parties from the second features.

More specifically, the event detection infrastructure can use single source probabilities to detect and/or validate events. For example, the event detection infrastructure can detect an event of interest to one or more parties based on a single source probability of a first signal and a single source probability of second signal collectively. Alternately, the event detection infrastructure can detect a possible event of interest to one or more parties based on single source probabilities of a first one or more signals. The event detection infrastructure can validate the possible event as an actual event of interest to one or more parties based on single source probabilities of a second one or more signals.

The event detection infrastructure can group normalized signals having sufficient temporal similarity and/or sufficient spatial similarity to one another in a signal sequence. Temporal similarity of normalized signals can be determined by comparing Time (T) of the normalized signals. In one aspect, temporal similarity of a normalized signal and another normalized signal is sufficient when the Time (T) of the normalized signal is within a specified time of the Time (T) of the other normalized signal. A specified time can be virtually any time value, such as, for example, ten seconds, 30 seconds, one minute, two minutes, five minutes, ten minutes, 30 minutes, one hour, two hours, four hours, etc. A specified time can vary by detection type. For example, some event types (e.g., a fire) inherently last longer than other types of events (e.g., a shooting). Specified times can be tailored per detection type.

Spatial similarity of normalized signals can be determined by comparing Location (L) of the normalized signals. In one aspect, spatial similarity of a normalized signal and another normalized signal is sufficient when the Location (L) of the normalized signal is within a specified distance of the Location (L) of the other normalized signal. A specified distance can be virtually any distance value, such as, for example, a linear distance or radius (a number of feet, meters, miles, kilometers, etc.), within a specified number of geo cells of specified precision, etc.

In one aspect, any normalized signal having sufficient temporal and spatial similarity to another normalized signal can be added to a signal sequence.

In another aspect, a single source probability for a signal is computed from features of the signal. The single source probability can reflect a mathematical probability or approximation of a mathematical probability of an event actually occurring. A normalized signal having a signal source probability above a threshold (e.g., greater than 4%) is indicated as an “elevated” signal. Elevated signals can be used to initiate and/or can be added to a signal sequence. On the other hand, non-elevated signals may not be added to a signal sequence.

In one aspect, a first threshold is considered for signal sequence initiation and a second threshold is considered for adding additional signals to an existing signal sequence. A normalized signal having a single source probability above the first threshold can be used to initiate a signal sequence. After a signal sequence is initiated, any normalized signal having a single source probability above the second threshold can be added to the signal sequence.

The first threshold can be greater than the second threshold. For example, the first threshold can be 4% or 5% and the second threshold can be 2% or 3%. Thus, signals that are not necessarily reliable enough to initiate a signal sequence for an event can be considered for validating a possible event.

The event detection infrastructure can derive features of a signal grouping, such as, a signal sequence. Features of a signal sequence can include features of signals in the signal sequence, including single source probabilities. Features of a signal sequence can also include percentages, histograms, counts, durations, etc. derived from features of the signals included in the signal sequence. The event detection infrastructure can detect an event of interest to one or more parties from signal sequence features.

The event detection infrastructure can include one or more multi-source classifiers. A multi-source classifier can compute a multi-source probability for a signal sequence from features of the signal sequence. The multi-source probability can reflect a mathematical probability or approximation of a mathematical probability of an event (e.g., fire, accident, weather, police presence, etc.) actually occurring based on multiple normalized signals (e.g., the signal sequence). The multi-source probability can be assigned as an additional signal sequence feature. A multi-source classifier can be configured to compute a multi-source probability for a single event type or to compute a multi-source probability for each of a plurality of different event types. A multi-source classifier can compute a multi-source probability using artificial intelligence, machine learning, neural networks, etc.

A multi-source probability can change over time as a signal sequence ages or when a new signal is added to a signal sequence. For example, a multi-source probability for a signal sequence can decay over time. A multi-source probability for a signal sequence can also be recomputed when a new normalized signal is added to the signal sequence.

Multi-source probability decay can start after a specified period of time (e.g., 3 minutes) and decay can occur in accordance with a defined decay equation. In one aspect, a decay equation defines exponential decay of multi-source probabilities. Different decay rates can be used for different classes. Decay can be similar to radioactive decay, with different tau (i.e., mean lifetime) values used to calculate the “half life” of multi-source probability for different event types.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: raw signals, normalized signals, signal features, aggregated features, single source probabilities, possible events, events, signal sequences, signal sequence features, multisource probabilities, thresholds, decay parameters, designated market areas (DMAs), contexts, location annotations, context annotations, classification tags, context dimensions etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, raw signals, normalized signals, signal features, aggregated features, single source probabilities, possible events, events, signal sequences, signal sequence features, multisource probabilities, thresholds, decay parameters, designated market areas (DMAs), contexts, location annotations, context annotations, classification tags, context dimensions etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware, software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

In this description and the following claims, a “geo cell” is defined as a piece of “cell” in a grid in any form. In one aspect, geo cells are arranged in a hierarchical structure. Cells of different geometries can be used.

A “geohash” is an example of a “geo cell”.

In this description and the following claims, “geohash” is defined as a geocoding system which encodes a geographic location into a short string of letters and digits. Geohash is a hierarchical spatial data structure which subdivides space into buckets of grid shape (e.g., a square). Geohashes offer properties like arbitrary precision and the possibility of gradually removing characters from the end of the code to reduce its size (and gradually lose precision). As a consequence of the gradual precision degradation, nearby places will often (but not always) present similar prefixes. The longer a shared prefix is, the closer the two places are. geo cells can be used as a unique identifier and to represent point data (e.g., in databases).

In one aspect, a “geohash” is used to refer to a string encoding of an area or point on the Earth. The area or point on the Earth may be represented (among other possible coordinate systems) as a latitude/longitude or Easting/Northing—the choice of which is dependent on the coordinate system chosen to represent an area or point on the Earth. geo cell can refer to an encoding of this area or point, where the geo cell may be a binary string comprised of 0s and 1s corresponding to the area or point, or a string comprised of 0s, 1s, and a ternary character (such as X)—which is used to refer to a don't care character (0 or 1). A geo cell can also be represented as a string encoding of the area or point, for example, one possible encoding is base-32, where every 5 binary characters are encoded as an ASCII character.

Depending on latitude, the size of an area defined at a specified geo cell precision can vary. When geohash is used for spatial indexing, the areas defined at various geo cell precisions are approximately:

| GeoHash Length/Precision | Width × Height |
|---|---|
| 1 | 5,009.4 km × 4,992.6 km |
| 2 | 1,252.3 km × 624.1 km |
| 3 | 156.5 km × 156 km |
| 4 | 39.1 km × 19.5 km |
| 5 | 4.9 km × 4.9 km |
| 6 | 1.2 km × 609.4 m |
| 7 | 152.9 m × 152.4 m |
| 8 | 38.2 m × 19 m |
| 9 | 4.8 m × 4.8 m |
| 10 | 1.2 m × 59.5 cm |
| 11 | 14.9 cm × 14.9 cm |
| 12 | 3.7 cm × 1.9 cm |

Other geo cell geometries, such as, hexagonal tiling, triangular tiling, etc. are also possible. For example, the H3 geospatial indexing system is a multi-precision hexagonal tiling of a sphere (such as the Earth) indexed with hierarchical linear indexes.

In another aspect, geo cells are a hierarchical decomposition of a sphere (such as the Earth) into representations of regions or points based a Hilbert curve (e.g., the S2 hierarchy or other hierarchies). Regions/points of the sphere can be projected into a cube and each face of the cube includes a quad-tree where the sphere point is projected into. After that, transformations can be applied and the space discretized. The geo cells are then enumerated on a Hilbert Curve (a space-filling curve that converts multiple dimensions into one dimension and preserves the locality).

Due to the hierarchical nature of geo cells, any signal, event, entity, etc., associated with a geo cell of a specified precision is by default associated with any less precise geo cells that contain the geo cell. For example, if a signal is associated with a geo cell of precision 9, the signal is by default also associated with corresponding geo cells of precisions 1, 2, 3, 4, 5, 6, 7, and 8. Similar mechanisms ae applicable to other tiling and geo cell arrangements. For example, S2 has a cell level hierarchy ranging from level zero (85,011,012 km²) to level 30 (between 0.48 cm² to 0.96 cm²).

Signal Ingestion and Normalization

Signal ingestion modules ingest a variety of raw structured and/or unstructured signals on an on going basis and in essentially real-time. Raw signals can include social posts, live broadcasts, traffic camera feeds, other camera feeds (e.g., from other public cameras or from CCTV cameras), listening device feeds, 911 calls, weather data, planned events, IoT device data, crowd sourced traffic and road information, satellite data, air quality sensor data, smart city sensor data, public radio communication (e.g., among first responders and/or dispatchers, between air traffic controllers and pilots), etc. The content of raw signals can include images, video, audio, text, etc. Generally, the signal ingestion modules normalize raw signals into normalized signals, for example, having a Time, Location, Context (or “TLC”) format.

Different types of ingested signals (e.g., social media signals, web signals, and streaming signals) can be used to identify events. Different types of signals can include different data types and different data formats. Data types can include audio, video, image, and text. Different formats can include text in XML, text in JavaScript Object Notation (JSON), text in RSS feed, plain text, video stream in Dynamic Adaptive Streaming over HTTP (DASH), video stream in HTTP Live Streaming (HLS), video stream in Real-Time Messaging Protocol (RTMP), etc.

Time (T) can be a time of origin or “event time” of a signal. In one aspect, a raw signal includes a time stamp and the time stamp is used to calculate Time (T). Location (L) can be anywhere across a geographic area, such as, a country (e.g., the United States), a State, a defined area, an impacted area, an area defined by a geo cell, an address, etc.

Context indicates circumstances surrounding formation/origination of a raw signal in terms that facilitate understanding and assessment of the raw signal. The context of a raw signal can be derived from express as well as inferred signal features of the raw signal.

Signal ingestion modules can include one or more single source classifiers. A single source classifier can compute a single source probability for a raw signal from features of the raw signal. A single source probability can reflect a mathematical probability or approximation of a mathematical probability (e.g., a percentage between 0%-100%) of an event (e.g., fire, accident, weather, police presence, shooting, power outage, etc.) actually occurring. A single source classifier can be configured to compute a single source probability for a single event type or to compute a single source probability for each of a plurality of different event types. A single source classifier can compute a single source probability using artificial intelligence, machine learning, neural networks, logic, heuristics, etc.

As such, single source probabilities and corresponding probability details can represent Context (C). Probability details can indicate (e.g., can include a hash field indicating) a probability version and (express and/or inferred) signal features considered in a signal source probability calculation.

Per signal type and signal content, different normalization modules can be used to extract, derive, infer, etc. time, location, and context from/for a raw signal. For example, one set of normalization modules can be configured to extract/derive/infer time, location and context from/for social signals. Another set of normalization modules can be configured to extract/derive/infer time, location and context from/for Web signals. A further set of normalization modules can be configured to extract/derive/infer time, location and context from/for streaming signals.

Normalization modules for extracting/deriving/inferring time, location, and context can include text processing modules, NLP modules, image processing modules, video processing modules, etc. The modules can be used to extract/derive/infer data representative of time, location, and context for a signal. Time, Location, and Context for a signal can be extracted/derived/inferred from metadata and/or content of the signal.

For example, NLP modules can analyze metadata and content of a sound clip to identify a time, location, and keywords (e.g., fire, shooter, etc.). An acoustic listener can also interpret the meaning of sounds in a sound clip (e.g., a gunshot, vehicle collision, etc.) and convert to relevant context. Live acoustic listeners can determine the distance and direction of a sound. Similarly, image processing modules can analyze metadata and pixels in an image to identify a time, location and keywords (e.g., fire, shooter, etc.). Image processing modules can also interpret the meaning of parts of an image (e.g., a person holding a gun, flames, a store logo, etc.) and convert to relevant context. Other modules can perform similar operations for other types of content including text and video.

Per signal type, each set of normalization modules can differ but may include at least some similar modules or may share some common modules. For example, similar (or the same) image analysis modules can be used to extract named entities from social signal images and public camera feeds. Likewise, similar (or the same) NLP modules can be used to extract named entities from social signal text and web text.

In some aspects, an ingested signal includes sufficient expressly defined time, location, and context information upon ingestion. The expressly defined time, location, and context information is used to determine Time, Location, and Context dimensions for the ingested signal. In other aspects, an ingested signal lacks expressly defined location information or expressly defined location information is insufficient (e.g., lacks precision) upon ingestion. In these other aspects, Location dimension or additional Location dimension can be inferred from features of an ingested signal and/or through references to other data sources. In further aspects, an ingested signal lacks expressly defined context information or expressly defined context information is insufficient (e.g., lacks precision) upon ingestion. In these further aspects, Context dimension or additional Context dimension can be inferred from features of an ingested signal and/or through reference to other data sources. [00%] In further aspects, time information may not be included, or included time information may not be given with high enough precision and Time dimension is inferred. For example, a user may post an image to a social network which had been taken some indeterminate time earlier.

Normalization modules can use named entity recognition and reference to a geo cell database to infer Location dimension. Named entities can be recognized in text, images, video, audio, or sensor data. The recognized named entities can be compared to named entities in geo cell entries. Matches indicate possible signal origination in a geographic area defined by a geo cell.

As such, a normalized signal can include a Time, a Location, a Context (e.g., single source probabilities and probability details), a signal type, a signal source, and content.

A single source probability can be calculated by single source classifiers (e.g., machine learning models, artificial intelligence, neural networks, statistical models, etc.) that consider hundreds, thousands, or even more signal features of a signal. Single source classifiers can be based on binary models and/or multi-class models.

In one aspect, frequentist inference technique is used to determine a single source probability. A database maintains mappings between different combinations of signal properties and ratios of signals turning into events (a probability) for that combination of signal properties. The database is queried with the combination of signal properties. The database returns a ratio of signals having the signal properties turning into events. The ratio is assigned to the signal. A combination of signal properties can include: (1) event class (e.g., fire, accident, weather, etc.), (2) media type (e.g., text, image, audio, etc.), (3) source (e.g., twitter, traffic camera, first responder radio traffic, etc.), and (4) geo type (e.g., geo cell, region, or non-geo).

In another aspect, a single source probability is calculated by single source classifiers (e.g., machine learning models, artificial intelligence, neural networks, etc.) that consider hundreds, thousands, or even more signal features of a signal. Single source classifiers can be based on binary models and/or multi-class models.

Output from a single source classifier can be adjusted to more accurately represent a probability that a signal is a “true positive”. For example, 1,000 signals with classifier output of 0.9 may include 80% as true positives. Thus, single source probability can be adjusted to 0.8 to more accurately reflect probability of the signal being a True event. “Calibration” can be done in such a way that for any “calibrated score” the score reflects the true probability of a true positive outcome.

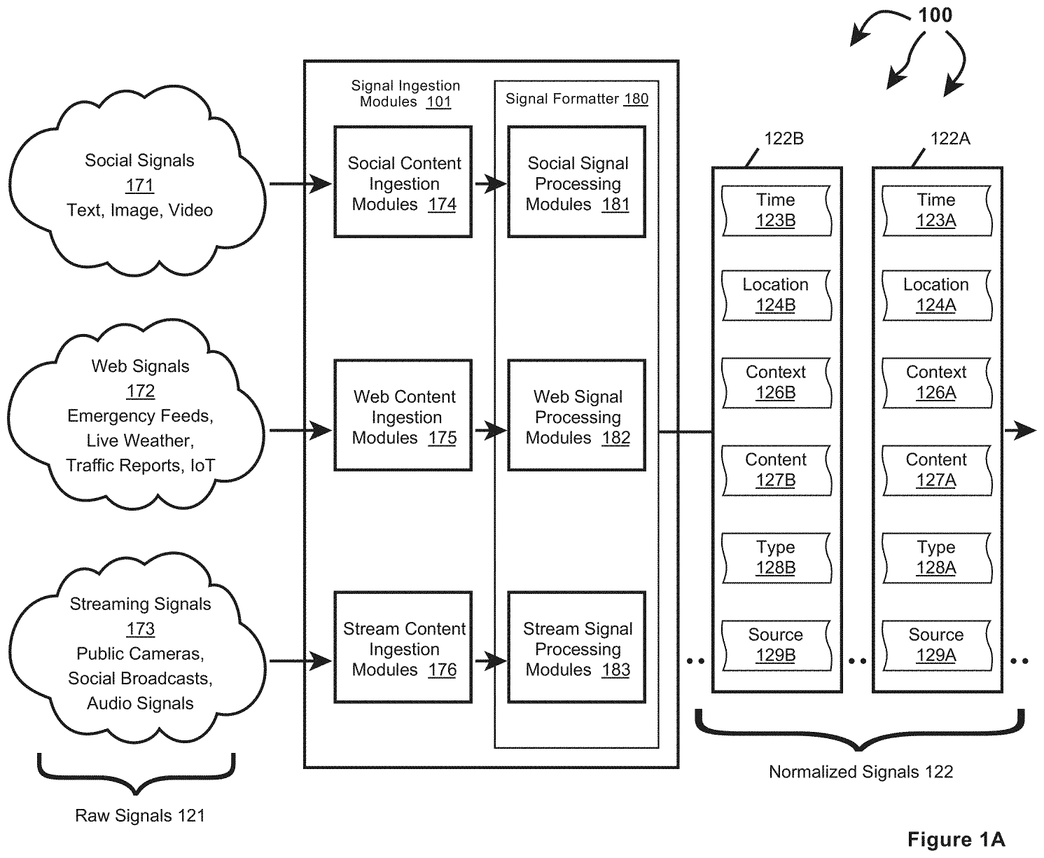

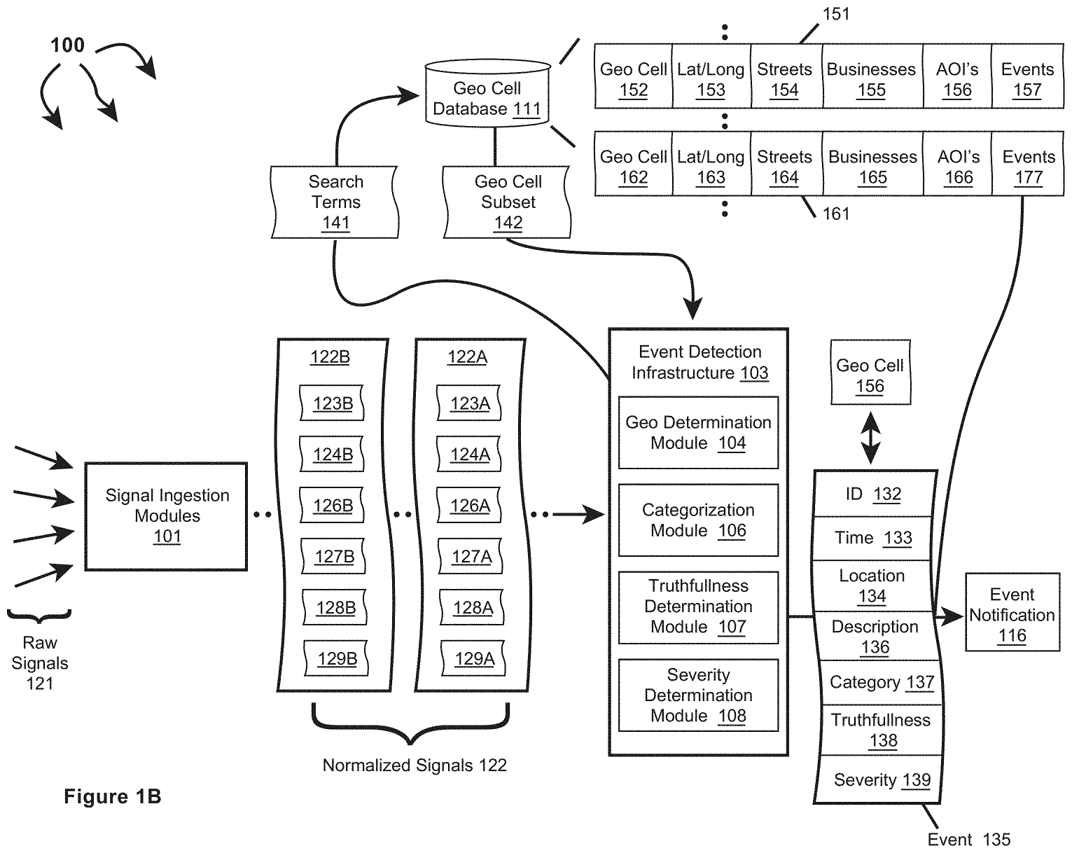

FIG. 1A depicts part of computer architecture 100 that facilitates ingesting and normalizing signals. As depicted, computer architecture 100 includes signal ingestion modules 101, social signals 171, Web signals 172, and streaming signals 173. Signal ingestion modules 101, social signals 171, Web signals 172, and streaming signals 173 can be connected to (or be part of) a network, such as, for example, a system bus, a Local Area Network (“LAN”), a Wide Area Network (“WAN”), and even the Internet. Accordingly, signal ingestion modules 101, social signals 171, Web signals 172, and streaming signals 173 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Signal ingestion module(s) 101 can ingest raw signals 121, including social signals 171, web signals 172, and streaming signals 173 (e.g., social posts, traffic camera feeds, other camera feeds, listening device feeds, 911 calls, weather data, planned events, IoT device data, crowd sourced traffic and road information, satellite data, air quality sensor data, smart city sensor data, public radio communication, etc.) on going basis and in essentially real-time. Signal ingestion module(s) 101 include social content ingestion modules 174, web content ingestion modules 176, stream content ingestion modules 177, and signal formatter 180. Signal formatter 180 further includes social signal processing module 181, web signal processing module 182, and stream signal processing modules 183.

For each type of signal, a corresponding ingestion module and signal processing module can interoperate to normalize the signal into a Time, Location, Context (TLC) dimensions. For example, social content ingestion modules 174 and social signal processing module 181 can interoperate to normalize social signals 171 into TLC dimensions. Similarly, web content ingestion modules 176 and web signal processing module 182 can interoperate to normalize web signals 172 into TLC dimensions. Likewise, stream content ingestion modules 177 and stream signal processing modules 183 can interoperate to normalize streaming signals 173 into TLC dimensions.

In one aspect, signal content exceeding specified size requirements (e.g., audio or video) is cached upon ingestion. Signal ingestion modules 101 include a URL or other identifier to the cached content within the context for the signal.

In one aspect, signal formatter 180 includes modules for determining a single source probability as a ratio of signals turning into events based on the following signal properties: (1) event class (e.g., fire, accident, weather, etc.), (2) media type (e.g., text, image, audio, etc.), (3) source (e.g., twitter, traffic camera, first responder radio traffic, etc.), and (4) geo type (e.g., geo cell, region, or non-geo). Probabilities can be stored in a lookup table for different combinations of the signal properties. Features of a signal can be derived and used to query the lookup table. For example, the lookup table can be queried with terms (“accident”, “image”, “twitter”, “region”). The corresponding ratio (probability) can be returned from the table.

In another aspect, signal formatter 180 includes a plurality of single source classifiers (e.g., artificial intelligence, machine learning modules, neural networks, etc.). Each single source classifier can consider hundreds, thousands, or even more signal features of a signal. Signal features of a signal can be derived and submitted to a signal source classifier. The single source classifier can return a probability that a signal indicates a type of event. Single source classifiers can be binary classifiers or multi-source classifiers.

Raw classifier output can be adjusted to more accurately represent a probability that a signal is a “true positive”. For example, 1,000 signals whose raw classifier output is 0.9 may include 80% as true positives. Thus, probability can be adjusted to 0.8 to reflect true probability of the signal being a true positive. “Calibration” can be done in such a way that for any “calibrated score” this score reflects the true probability of a true positive outcome.

Signal ingestion modules 101 can insert one or more single source probabilities and corresponding probability details into a normalized signal to represent a Context (C) dimension. Probability details can indicate a probabilistic model and features used to calculate the probability. In one aspect, a probabilistic model and signal features are contained in a hash field.

Signal ingestion modules 101 can access “transdimensionality” transformations structured and defined in a “TLC” dimensional model. Signal ingestion modules 101 can apply the “transdimensionality” transformations to generic source data in raw signals to re-encode the source data into normalized data having lower dimensionality. Dimensionality reduction can include reducing dimensionality of a raw signal to a normalized signal including a T vector, an L vector, and a C vector. At lower dimensionality, the complexity of measuring “distances” between dimensional vectors across different normalized signals is reduced.

Thus, in general, any received raw signals can be normalized into normalized signals including a Time (T) dimension, a Location (L) dimension, a Context (C) dimension, signal source, signal type, and content. Signal ingestion modules 101 can send normalized signals 122 to event detection infrastructure 103.

For example, signal ingestion modules 101 can send normalized signal 122A, including time 123A, location 124A, context 126A, content 127A, type 128A, and source 129A to event detection infrastructure 103. Similarly, signal ingestion modules 101 can send normalized signal 122B, including time 123B, location 124B, context 126B, content 127B, type 128B, and source 129B to event detection infrastructure 103.

Event Detection

FIG. 1B depicts part of computer architecture 100 that facilitates detecting events. As depicted, computer architecture 100 includes geo cell database 111 and even notification 116. Geo cell database 111 and event notification 116 can be connected to (or be part of) a network with signal ingestion modules 101 and event detection infrastructure 103. As such, geo cell database 111 and even notification 116 can create and exchange message related data over the network.

As described, in general, on an ongoing basis, concurrently with signal ingestion (and also essentially in real-time), event detection infrastructure 103 detects different categories of (planned and unplanned) events (e.g., fire, police response, mass shooting, traffic accident, natural disaster, storm, active shooter, concerts, protests, power outage, etc.) in different locations (e.g., anywhere across a geographic area, such as, the United States, a State, a defined area, an impacted area, an area defined by a geo cell, an address, etc.), at different times from Time, Location, and Context dimensions included in normalized signals. Since, normalized signals are normalized to include Time, Location, and Context dimensions, event detection infrastructure 103 can handle normalized signals in a more uniform manner increasing event detection efficiency and effectiveness.

Event detection infrastructure 103 can also determine an event truthfulness, event severity, and an associated geo cell. In one aspect, a Context dimension in a normalized signal increases the efficiency and effectiveness of determining truthfulness, severity, and an associated geo cell.

Generally, an event truthfulness indicates how likely a detected event is actually an event (vs. a hoax, fake, misinterpreted, etc.). Truthfulness can range from less likely to be true to more likely to be true. In one aspect, truthfulness is represented as a numerical value, such as, for example, from 1 (less truthful) to 10 (more truthful) or as percentage value in a percentage range, such as, for example, from 0% (less truthful) to 100% (more truthful). Other truthfulness representations are also possible. For example, truthfulness can be a dimension or represented by one or more vectors.

Generally, an event severity indicates how severe an event is (e.g., what degree of badness, what degree of damage, etc. is associated with the event). Severity can range from less severe (e.g., a single vehicle accident without injuries) to more severe (e.g., multi vehicle accident with multiple injuries and a possible fatality). As another example, a shooting event can also range from less severe (e.g., one victim without life threatening injuries) to more severe (e.g., multiple injuries and multiple fatalities). In one aspect, severity is represented as a numerical value, such as, for example, from 1 (less severe) to 5 (more severe). Other severity representations are also possible. For example, severity can be a dimension or represented by one or more vectors.

In general, event detection infrastructure 103 can include a geo determination module including modules for processing different kinds of content including location, time, context, text, images, audio, and video into search terms. The geo determination module can query a geo cell database with search terms formulated from normalized signal content. The geo cell database can return any geo cells having matching supplemental information. For example, if a search term includes a street name, a subset of one or more geo cells including the street name in supplemental information can be returned to the event detection infrastructure.

Event detection infrastructure 103 can use the subset of geo cells to determine a geo cell associated with an event location. Events associated with a geo cell can be stored back into an entry for the geo cell in the geo cell database. Thus, over time an historical progression of events within a geo cell can be accumulated.

As such, event detection infrastructure 103 can assign an event ID, an event time, an event location, an event category, an event description, an event truthfulness, and an event severity to each detected event. Detected events can be sent to relevant entities, including to mobile devices, to computer systems, to APIs, to data storage, etc.

Event detection infrastructure 103 detects events from information contained in normalized signals 122. Event detection infrastructure 103 can detect an event from a single normalized signal 122 or from multiple normalized signals 122. In one aspect, event detection infrastructure 103 detects an event based on information contained in one or more normalized signals 122. In another aspect, event detection infrastructure 103 detects a possible event based on information contained in one or more normalized signals 122. Event detection infrastructure 103 then validates the potential event as an event based on information contained in one or more other normalized signals 122.

As depicted, event detection infrastructure 103 includes geo determination module 104, categorization module 106, truthfulness determination module 107, and severity determination module 108.

Geo determination module 104 can include NLP modules, image analysis modules, etc. for identifying location information from a normalized signal. Geo determination module 104 can formulate (e.g., location) search terms 141 by using NLP modules to process audio, using image analysis modules to process images, etc. Search terms can include street addresses, building names, landmark names, location names, school names, image fingerprints, etc. Event detection infrastructure 103 can use a URL or identifier to access cached content when appropriate.

Categorization module 106 can categorize a detected event into one of a plurality of different categories (e.g., fire, police response, mass shooting, traffic accident, natural disaster, storm, active shooter, concerts, protests, power outage, etc.) based on the content of normalized signals used to detect and/or otherwise related to an event.

Truthfulness determination module 107 can determine the truthfulness of a detected event based on one or more of: source, type, age, and content of normalized signals used to detect and/or otherwise related to the event. Some signal types may be inherently more reliable than other signal types. For example, video from a live traffic camera feed may be more reliable than text in a social media post. Some signal sources may be inherently more reliable than others. For example, a social media account of a government agency may be more reliable than a social media account of an individual. The reliability of a signal can decay over time.

Severity determination module 108 can determine the severity of a detected event based on or more of: location, content (e.g., dispatch codes, keywords, etc.), and volume of normalized signals used to detect and/or otherwise related to an event. Events at some locations may be inherently more severe than events at other locations. For example, an event at a hospital is potentially more severe than the same event at an abandoned warehouse. Event category can also be considered when determining severity. For example, an event categorized as a “Shooting” may be inherently more severe than an event categorized as “Police Presence” since a shooting implies that someone has been injured.

Geo cell database 111 includes a plurality of geo cell entries. Each geo cell entry is included in a geo cell defining an area and corresponding supplemental information about things included in the defined area. The corresponding supplemental information can include latitude/longitude, street names in the area defined by and/or beyond the geo cell, businesses in the area defined by the geo cell, other Areas of Interest (AOIs) (e.g., event venues, such as, arenas, stadiums, theaters, concert halls, etc.) in the area defined by the geo cell, image fingerprints derived from images captured in the area defined by the geo cell, and prior events that have occurred in the area defined by the geo cell. For example, geo cell entry 151 includes geo cell 152, lat/lon 153, streets 154, businesses 155, AIs 156, and prior events 157. Each event in prior events 157 can include a location (e.g., a street address), a time (event occurrence time), an event category, an event truthfulness, an event severity, and an event description. Similarly, geo cell entry 161 includes geo cell 162, lat/lon 163, streets 164, businesses 165, AIs 166, and prior events 167. Each event in prior events 167 can include a location (e.g., a street address), a time (event occurrence time), an event category, an event truthfulness, an event severity, and an event description.

Other geo cell entries can include the same or different (more or less) supplemental information, for example, depending on infrastructure density in an area. For example, a geo cell entry for an urban area can contain more diverse supplemental information than a geo cell entry for an agricultural area (e.g., in an empty field).

Geo cell database 111 can store geo cell entries in a hierarchical arrangement based on geo cell precision. As such, geo cell information of more precise geo cells is included in the geo cell information for any less precise geo cells that include the more precise geo cell.

Geo determination module 104 can query geo cell database 111 with search terms 141. Geo cell database 111 can identify any geo cells having supplemental information that matches search terms 141. For example, if search terms 141 include a street address and a business name, geo cell database 111 can identify geo cells having the street name and business name in the area defined by the geo cell. Geo cell database 111 can return any identified geo cells to geo determination module 104 in geo cell subset 142.

Geo determination module can use geo cell subset 142 to determine the location of event 135 and/or a geo cell associated with event 135. As depicted, event 135 includes event ID 132, time 133, location 137, description 136, category 137, truthfulness 138, and severity 139.

Event detection infrastructure 103 can also determine that event 135 occurred in an area defined by geo cell 162 (e.g., a geohash having precision of level 7 or level 9). For example, event detection infrastructure 103 can determine that location 134 is in the area defined by geo cell 162. As such, event detection infrastructure 103 can store event 135 in events 167 (i.e., historical events that have occurred in the area defined by geo cell 162).

Event detection infrastructure 103 can also send event 135 to event notification module 116. Event notification module 116 can notify one or more entities about event 135.

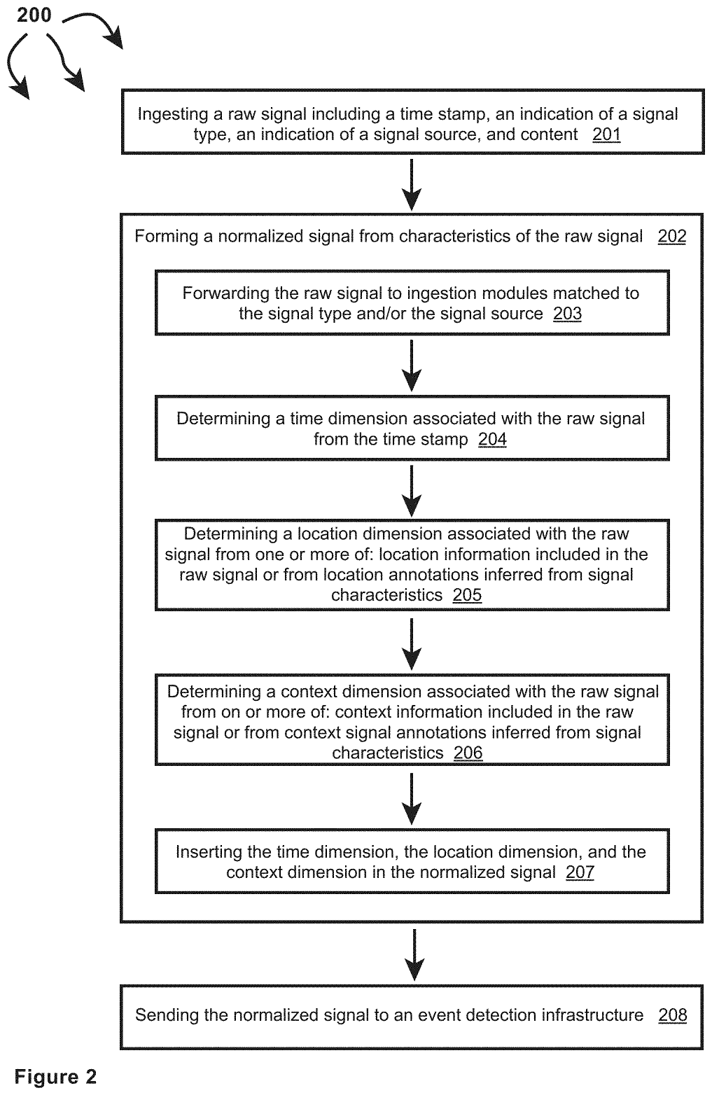

FIG. 2 illustrates a flow chart of an example method 200 for normalizing ingested signals. Method 200 will be described with respect to the components and data in computer architecture 100.

Method 200 includes ingesting a raw signal including a time stamp, an indication of a signal type, an indication of a signal source, and content (201). For example, signal ingestion modules 101 can ingest a raw signal 121 from one of: social signals 171, web signals 172, or streaming signals 173.

Method 200 incudes forming a normalized signal from characteristics of the raw signal (202). For example, signal ingestion modules 101 can form a normalized signal 122A from the ingested raw signal 121.

Forming a normalized signal includes forwarding the raw signal to ingestion modules matched to the signal type and/or the signal source (203). For example, if ingested raw signal 121 is from social signals 171, raw signal 121 can be forwarded to social content ingestion modules 174 and social signal processing modules 181. If ingested raw signal 121 is from web signals 172, raw signal 121 can be forwarded to web content ingestion modules 175 and web signal processing modules 182. If ingested raw signal 121 is from streaming signals 173, raw signal 121 can be forwarded to streaming content ingestion modules 176 and streaming signal processing modules 183.

Forming a normalized signal includes determining a time dimension associated with the raw signal from the time stamp (204). For example, signal ingestion modules 101 can determine time 123A from a time stamp in ingested raw signal 121.

Forming a normalized signal includes determining a location dimension associated with the raw signal from one or more of: location information included in the raw signal or from location annotations inferred from signal characteristics (205). For example, signal ingestion modules 101 can determine location 124A from location information included in raw signal 121 or from location annotations derived from characteristics of raw signal 121 (e.g., signal source, signal type, signal content).

Forming a normalized signal includes determining a context dimension associated with the raw signal from one or more of: context information included in the raw signal or from context signal annotations inferred from signal characteristics (206). For example, signal ingestion modules 101 can determine context 126A from context information included in raw signal 121 or from context annotations derived from characteristics of raw signal 121 (e.g., signal source, signal type, signal content).

Forming a normalized signal includes inserting the time dimension, the location dimension, and the context dimension in the normalized signal (207). For example, signal ingestion modules 101 can insert time 123A, location 124A, and context 126A in normalized signal 122. Method 200 includes sending the normalized signal to an event detection infrastructure (208). For example, signal ingestion modules 101 can send normalized signal 122A to event detection infrastructure 103.

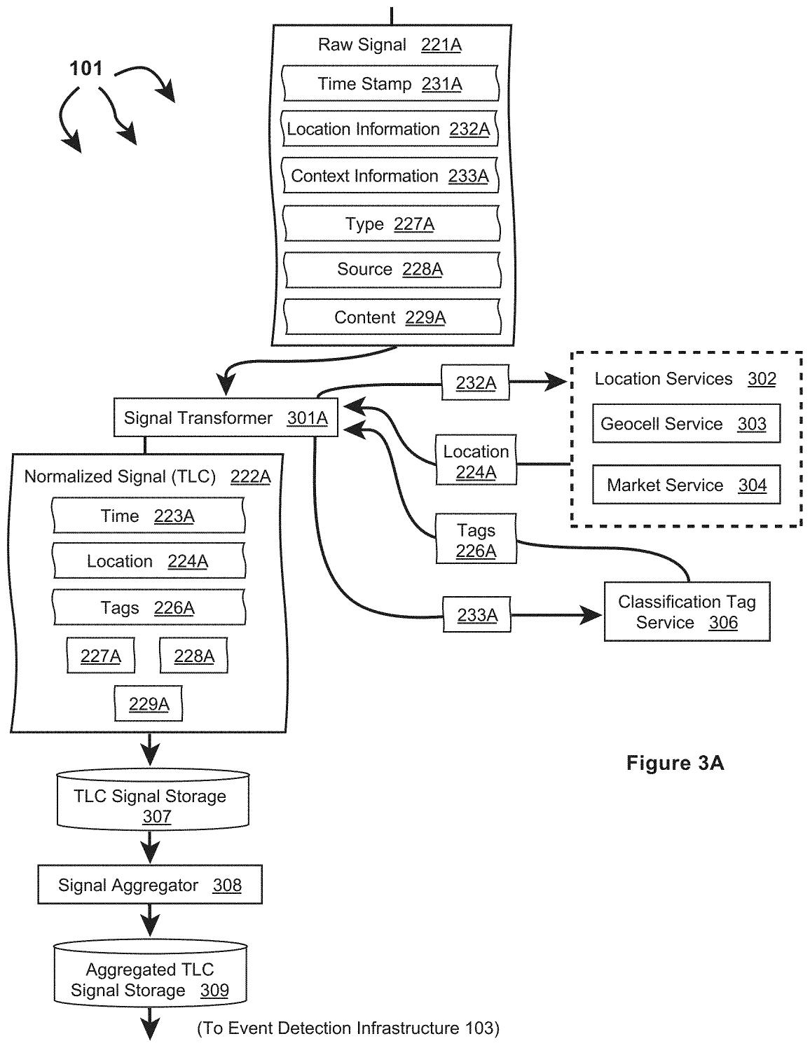

FIGS. 3A, 3B, and 3C depict other example components that can be included in signal ingestion modules 101. Signal ingestion modules 101 can include signal transformers for different types of signals including signal transformer 301A (for TLC signals), signal transformer 301B (for TL signals), and signal transformer 301C (for T signals). In one aspect, a single module combines the functionality of multiple different signal transformers.

Signal ingestion modules 101 can also include location services 302, classification tag service 306, signal aggregator 308, context inference module 312, and location inference module 316. Location services 302, classification tag service 306, signal aggregator 308, context inference module 312, and location inference module 316 or parts thereof can interoperate with and/or be integrated into any of ingestion modules 174, web content ingestion modules 176, stream content ingestion modules 177, social signal processing module 181, web signal processing module 182, and stream signal processing modules 183. Location services 302, classification tag service 306, signal aggregator 308, context inference module 312, and location inference module 316 can interoperate to implement “transdimensionality” transformations to reduce raw signal dimensionality.

Signal ingestion modules 101 can also include storage for signals in different stages of normalization, including TLC signal storage 307, TL signal storage 311, T signal storage 313, TC signal storage 314, and aggregated TLC signal storage 309. In one aspect, data ingestion modules 101 implement a distributed messaging system. Each of signal storage 307, 309, 311, 313, and 314 can be implemented as a message container (e.g., a topic) associated with a type of message.

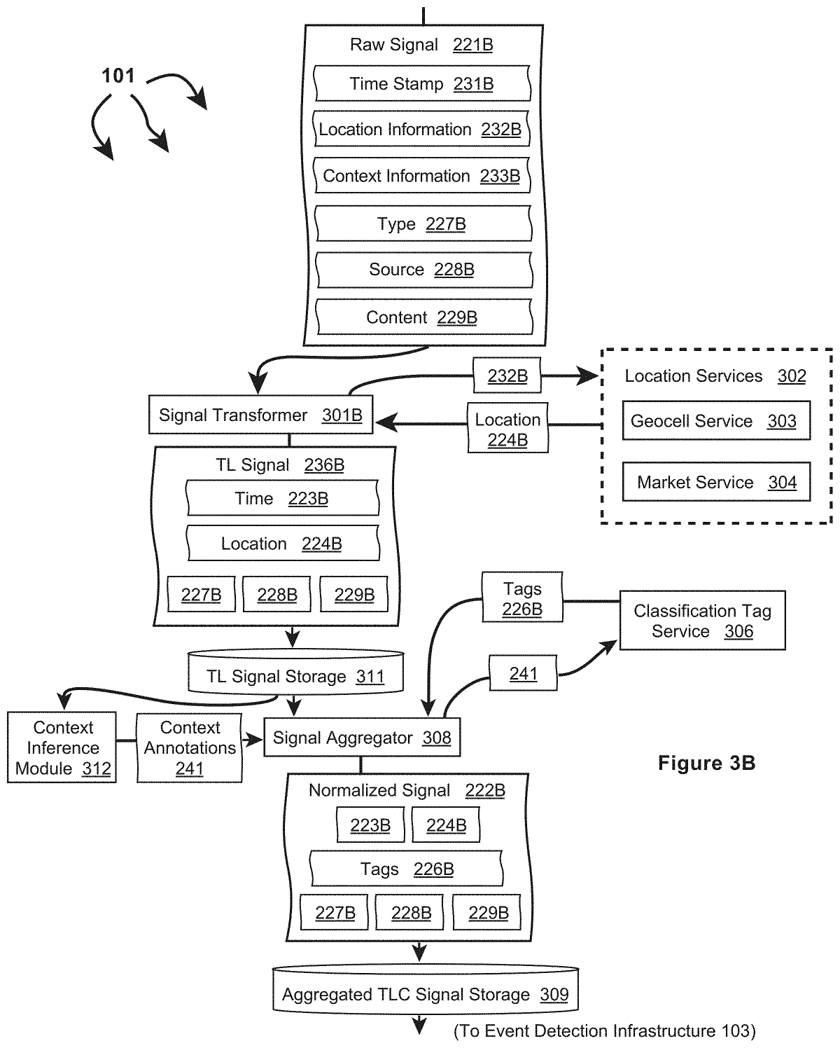

FIG. 4 illustrates a flow chart of an example method 400 for normalizing an ingested signal including time information, location information, and context information. Method 400 will be described with respect to the components and data in FIG. 3A.

Method 400 includes accessing a raw signal including a time stamp, location information, context information, an indication of a signal type, an indication of a signal source, and content (401). For example, signal transformer 301A can access raw signal 221A. Raw signal 221A includes timestamp 231A, location information 232A (e.g., lat/lon, GPS coordinates, etc.), context information 233A (e.g., text expressly indicating a type of event), signal type 227A (e.g., social media, 911 communication, traffic camera feed, etc.), signal source 228A (e.g., Facebook, twitter, Waze, etc.), and signal content 229A (e.g., one or more of: image, video, text, keyword, locale, etc.).

Method 400 includes determining a Time dimension for the raw signal (402). For example, signal transformer 301A can determine time 223A from timestamp 231A.

Method 400 includes determining a Location dimension for the raw signal (403). For example, signal transformer 301A sends location information 232A to location services 302. Geo cell service 303 can identify a geo cell corresponding to location information 232A. Market service 304 can identify a designated market area (DMA) corresponding to location information 232A. Location services 302 can include the identified geo cell and/or DMA in location 224A. Location services 302 return location 224A to signal transformer 301.

Method 400 includes determining a Context dimension for the raw signal (404). For example, signal transformer 301A sends context information 233A to classification tag service 306. Classification tag service 306 identifies one or more classification tags 226A (e.g., fire, police presence, accident, natural disaster, etc.) from context information 233A. Classification tag service 306 returns classification tags 226A to signal transformer 301A.

Method 400 includes inserting the Time dimension, the Location dimension, and the Context dimension in a normalized signal (405). For example, signal transformer 301A can insert time 223A, location 224A, and tags 226A in normalized signal 222A (a TLC signal). Method 400 includes storing the normalized signal in signal storage (406). For example, signal transformer 301A can store normalized signal 222A in TLC signal storage 307. (Although not depicted, timestamp 231A, location information 232A, and context information 233A can also be included (or remain) in normalized signal 222A).

Method 400 includes storing the normalized signal in aggregated storage (406). For example, signal aggregator 308 can aggregate normalized signal 222A along with other normalized signals determined to relate to the same event. In one aspect, signal aggregator 308 forms a sequence of signals related to the same event. Signal aggregator 308 stores the signal sequence, including normalized signal 222A, in aggregated TLC storage 309 and eventually forwards the signal sequence to event detection infrastructure 103.

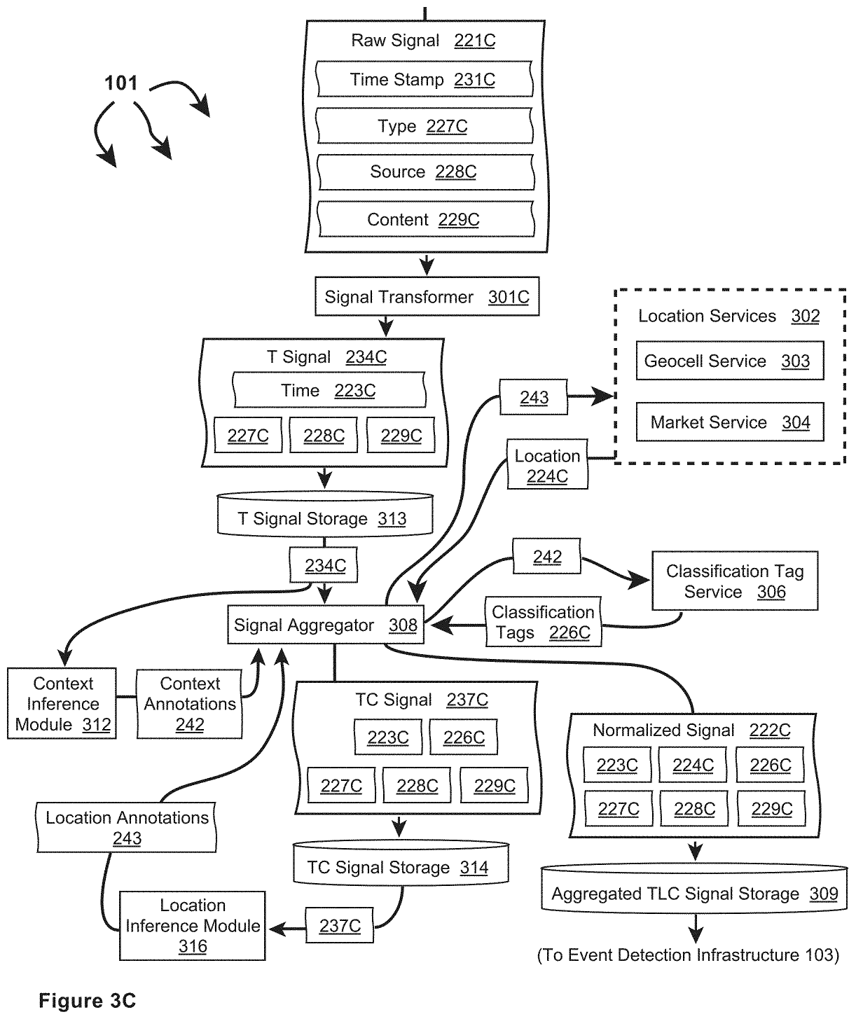

FIG. 5 illustrates a flow chart of an example method 500 for normalizing an ingested signal including time information and location information. Method 500 will be described with respect to the components and data in FIG. 3B.

Method 500 includes accessing a raw signal including a time stamp, location information, an indication of a signal type, an indication of a signal source, and content (501). For example, signal transformer 301B can access raw signal 221B. Raw signal 221B includes timestamp 231B, location information 232B (e.g., lat/lon, GPS coordinates, etc.), signal type 227B (e.g., social media, 911 communication, traffic camera feed, etc.), signal source 228B (e.g., Facebook, twitter, Waze, etc.), and signal content 229B (e.g., one or more of: image, video, audio, text, keyword, locale, etc.).

Method 500 includes determining a Time dimension for the raw signal (502). For example, signal transformer 301B can determine time 223B from timestamp 231B.

Method 500 includes determining a Location dimension for the raw signal (503). For example, signal transformer 301B sends location information 232B to location services 302. Geo cell service 303 can be identify a geo cell corresponding to location information 232B. Market service 304 can identify a designated market area (DMA) corresponding to location information 232B. Location services 302 can include the identified geo cell and/or DMA in location 224B. Location services 302 returns location 224B to signal transformer 301.

Method 500 includes inserting the Time dimension and Location dimension into a signal (504). For example, signal transformer 301B can insert time 223B and location 224B into TL signal 236B. (Although not depicted, timestamp 231B and location information 232B can also be included (or remain) in TL signal 236B). Method 500 includes storing the signal, along with the determined Time dimension and Location dimension, to a Time, Location message container (505). For example, signal transformer 301B can store TL signal 236B to TL signal storage 311. Method 500 includes accessing the signal from the Time, Location message container (506). For example, signal aggregator 308 can access TL signal 236B from TL signal storage 311.

Method 500 includes inferring context annotations based on characteristics of the signal (507). For example, context inference module 312 can access TL signal 236B from TL signal storage 311. Context inference module 312 can infer context annotations 241 from characteristics of TL signal 236B, including one or more of: time 223B, location 224B, type 227B, source 228B, and content 229B. In one aspect, context inference module 212 includes one or more of: NLP modules, audio analysis modules, image analysis modules, video analysis modules, etc. Context inference module 212 can process content 229B in view of time 223B, location 224B, type 227B, source 228B, to infer context annotations 241 (e.g., using machine learning, artificial intelligence, neural networks, machine classifiers, etc.). For example, if content 229B is an image that depicts flames and a fire engine, context inference module 212 can infer that content 229B is related to a fire. Context inference 212 module can return context annotations 241 to signal aggregator 208.

Method 500 includes appending the context annotations to the signal (508). For example, signal aggregator 308 can append context annotations 241 to TL signal 236B. Method 500 includes looking up classification tags corresponding to the classification annotations (509). For example, signal aggregator 308 can send context annotations 241 to classification tag service 306. Classification tag service 306 can identify one or more classification tags 226B (a Context dimension) (e.g., fire, police presence, accident, natural disaster, etc.) from context annotations 241. Classification tag service 306 returns classification tags 226B to signal aggregator 308.

Method 500 includes inserting the classification tags in a normalized signal (510). For example, signal aggregator 308 can insert tags 226B (a Context dimension) into normalized signal 222B (a TLC signal). Method 500 includes storing the normalized signal in aggregated storage (511). For example, signal aggregator 308 can aggregate normalized signal 222B along with other normalized signals determined to relate to the same event. In one aspect, signal aggregator 308 forms a sequence of signals related to the same event. Signal aggregator 308 stores the signal sequence, including normalized signal 222B, in aggregated TLC storage 309 and eventually forwards the signal sequence to event detection infrastructure 103. (Although not depicted, timestamp 231B, location information 232C, and context annotations 241 can also be included (or remain) in normalized signal 222B).

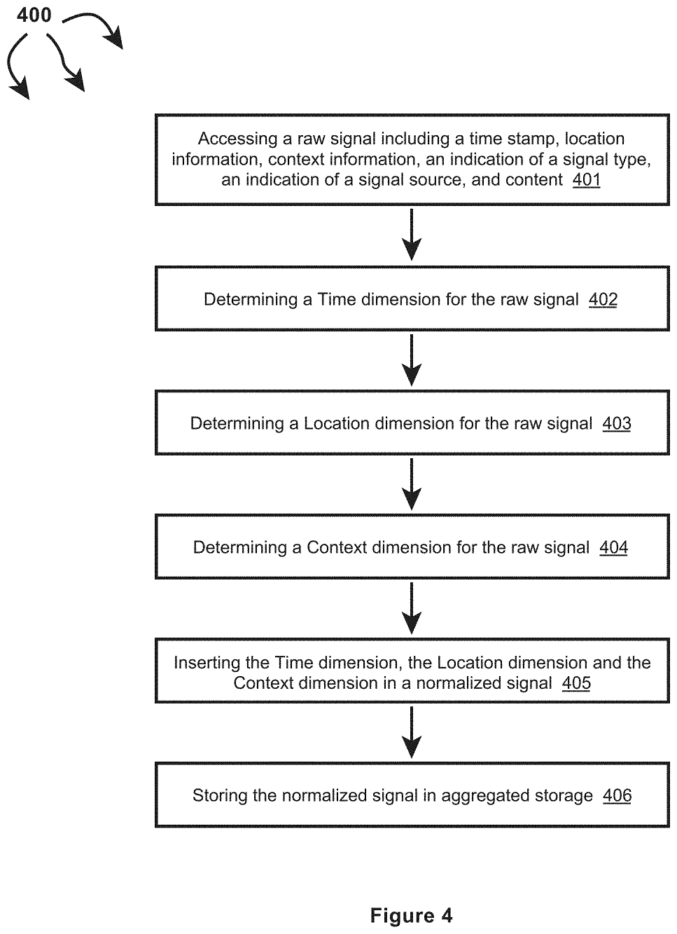

FIG. 6 illustrates a flow chart of an example method 600 for normalizing an ingested signal including time information and location information. Method 600 will be described with respect to the components and data in FIG. 3C.

Method 600 includes accessing a raw signal including a time stamp, an indication of a signal type, an indication of a signal source, and content (601). For example, signal transformer 301C can access raw signal 221C. Raw signal 221C includes timestamp 231C, signal type 227C (e.g., social media, 911 communication, traffic camera feed, etc.), signal source 228C (e.g., Facebook, twitter, Waze, etc.), and signal content 229C (e.g., one or more of: image, video, text, keyword, locale, etc.).

Method 600 includes determining a Time dimension for the raw signal (602). For example, signal transformer 301C can determine time 223C from timestamp 231C. Method 600 includes inserting the Time dimension into a T signal (603). For example, signal transformer 301C can insert time 223C into T signal 234C. (Although not depicted, timestamp 231C can also be included (or remain) in T signal 234C).

Method 600 includes storing the T signal, along with the determined Time dimension, to a Time message container (604). For example, signal transformer 301C can store T signal 236C to T signal storage 313. Method 600 includes accessing the T signal from the Time message container (605). For example, signal aggregator 308 can access T signal 234C from T signal storage 313.

Method 600 includes inferring context annotations based on characteristics of the T signal (606). For example, context inference module 312 can access T signal 234C from T signal storage 313. Context inference module 312 can infer context annotations 242 from characteristics of T signal 234C, including one or more of: time 223C, type 227C, source 228C, and content 229C. As described, context inference module 212 can include one or more of: NLP modules, audio analysis modules, image analysis modules, video analysis modules, etc. Context inference module 212 can process content 229C in view of time 223C, type 227C, source 228C, to infer context annotations 242 (e.g., using machine learning, artificial intelligence, neural networks, machine classifiers, etc.). For example, if content 229C is a video depicting two vehicles colliding on a roadway, context inference module 212 can infer that content 229C is related to an accident. Context inference 212 module can return context annotations 242 to signal aggregator 208.

Method 600 includes appending the context annotations to the T signal (607). For example, signal aggregator 308 can append context annotations 242 to T signal 234C. Method 600 includes looking up classification tags corresponding to the classification annotations (608). For example, signal aggregator 308 can send context annotations 242 to classification tag service 306. Classification tag service 306 can identify one or more classification tags 226C (a Context dimension) (e.g., fire, police presence, accident, natural disaster, etc.) from context annotations 242. Classification tag service 306 returns classification tags 226C to signal aggregator 208.

Method 600 includes inserting the classification tags into a TC signal (609). For example, signal aggregator 308 can insert tags 226C into TC signal 237C. Method 600 includes storing the TC signal to a Time, Context message container (610). For example, signal aggregator 308 can store TC signal 237C in TC signal storage 314. (Although not depicted, timestamp 231C and context annotations 242 can also be included (or remain) in normalized signal 237C).

Method 600 includes inferring location annotations based on characteristics of the TC signal (611). For example, location inference module 316 can access TC signal 237C from TC signal storage 314. Location inference module 316 can include one or more of: NLP modules, audio analysis modules, image analysis modules, video analysis modules, etc. Location inference module 316 can process content 229C in view of time 223C, type 227C, source 228C, and classification tags 226C (and possibly context annotations 242) to infer location annotations 243 (e.g., using machine learning, artificial intelligence, neural networks, machine classifiers, etc.). For example, if content 229C is a video depicting two vehicles colliding on a roadway, the video can include a nearby street sign, business name, etc. Location inference module 316 can infer a location from the street sign, business name, etc. Location inference module 316 can return location annotations 243 to signal aggregator 308.

Method 600 includes appending the location annotations to the TC signal with location annotations (612). For example, signal aggregator 308 can append location annotations 243 to TC signal 237C. Method 600 determining a Location dimension for the TC signal (613). For example, signal aggregator 308 can send location annotations 243 to location services 302. Geo cell service 303 can identify a geo cell corresponding to location annotations 243. Market service 304 can identify a designated market area (DMA) corresponding to location annotations 243. Location services 302 can include the identified geo cell and/or DMA in location 224C. Location services 302 returns location 224C to signal aggregation services 308.

Method 600 includes inserting the Location dimension into a normalized signal (614). For example, signal aggregator 308 can insert location 224C into normalized signal 222C. Method 600 includes storing the normalized signal in aggregated storage (615). For example, signal aggregator 308 can aggregate normalized signal 222C along with other normalized signals determined to relate to the same event. In one aspect, signal aggregator 308 forms a sequence of signals related to the same event. Signal aggregator 308 stores the signal sequence, including normalized signal 222C, in aggregated TLC storage 309 and eventually forwards the signal sequence to event detection infrastructure 103. (Although not depicted, timestamp 231B, context annotations 241, and location annotations 24, can also be included (or remain) in normalized signal 222B).

In another aspect, a Location dimension is determined prior to a Context dimension when a T signal is accessed. A Location dimension (e.g., geo cell and/or DMA) and/or location annotations are used when inferring context annotations.

Accordingly, location services 302 can identify a geo cell and/or DMA for a signal from location information in the signal and/or from inferred location annotations. Similarly, classification tag service 306 can identify classification tags for a signal from context information in the signal and/or from inferred context annotations.

Signal aggregator 308 can concurrently handle a plurality of signals in a plurality of different stages of normalization. For example, signal aggregator 308 can concurrently ingest and/or process a plurality T signals, a plurality of TL signals, a plurality of TC signals, and a plurality of TLC signals. Accordingly, aspects of the invention facilitate acquisition of live, ongoing forms of data into an event detection system with signal aggregator 308 acting as an “air traffic controller” of live data. Signals from multiple sources of data can be aggregated and normalized for a common purpose (e.g., of event detection). Data ingestion, event detection, and event notification can process data through multiple stages of logic with concurrency.

As such, a unified interface can handle incoming signals and content of any kind. The interface can handle live extraction of signals across dimensions of time, location, and context. In some aspects, heuristic processes are used to determine one or more dimensions. Acquired signals can include text and images as well as live-feed binaries, including live media in audio, speech, fast still frames, video streams, etc.

Signal normalization enables the world's live signals to be collected at scale and analyzed for detection and validation of live events happening globally. A data ingestion and event detection pipeline aggregates signals and combines detections of various strengths into truthful events. Thus, normalization increases event detection efficiency facilitating event detection closer to “live time” or at “moment zero”.

Multi-Signal Detection

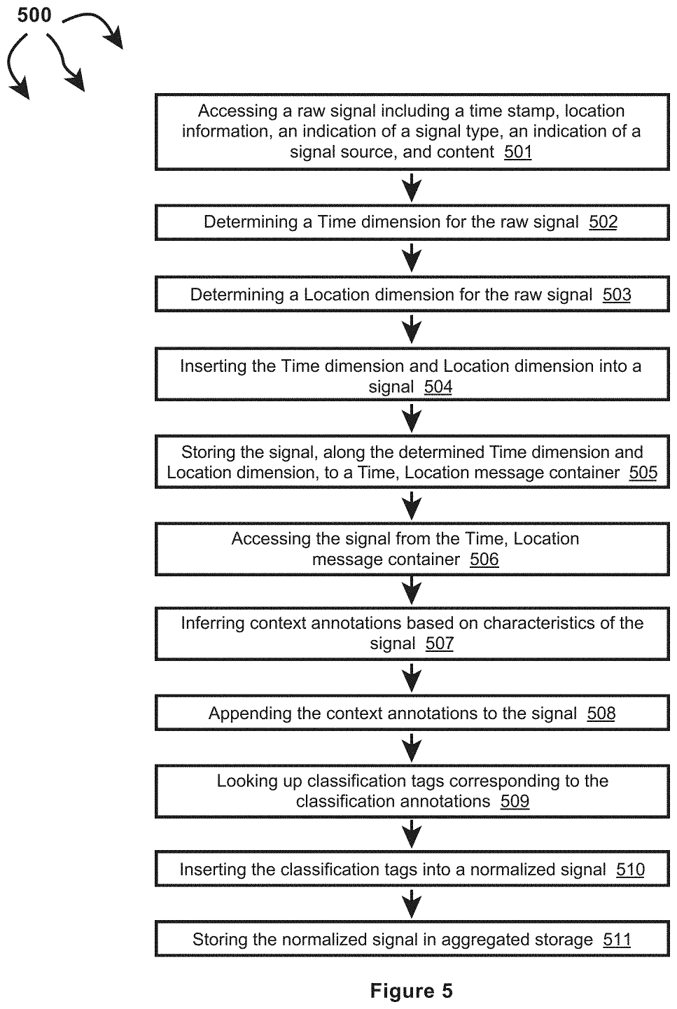

FIG. 7 illustrates an example computer architecture 700 that facilitates detecting an event from features derived from multiple signals. As depicted, computer architecture 700 further includes event detection infrastructure 103. Event infrastructure 103 can be connected to (or be part of) a network with signal ingestion modules 101. As such, signal ingestion modules 101 and event detection infrastructure 103 can create and exchange message related data over the network.

As depicted, event detection infrastructure 103 further includes evaluation module 706. Evaluation module 706 is configured to determine if features of a plurality of normalized signals collectively indicate an event. Evaluation module 706 can detect (or not detect) an event based on one or more features of one normalized signal in combination with one or more features of another normalized signal.

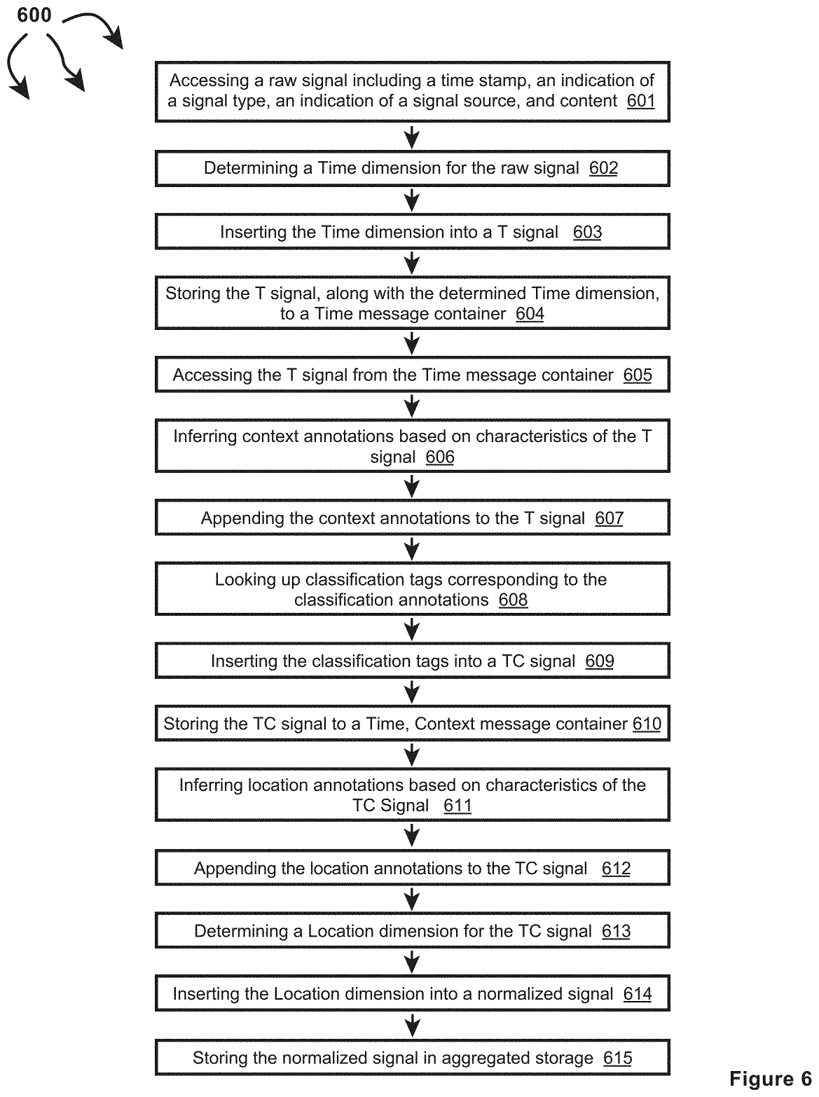

FIG. 8 illustrates a flow chart of an example method 800 for detecting an event from features derived from multiple signals. Method 800 will be described with respect to the components and data in computer architecture 700.

Method 800 includes receiving a first signal (801). For example, event detection infrastructure 103 can receive normalized signal 122B. Method 800 includes deriving first one or more features of the first signal (802). For example, event detection infrastructure 103 can derive features 701 of normalized signal 122B. Features 701 can include and/or be derived from time 123B, location 124B, context 126B, content 127B, type 128B, and source 129B. Event detection infrastructure 103 can also derive features 701 from one or more single source probabilities assigned to normalized signal 122B.

Method 800 includes determining that the first one or more features do not satisfy conditions to be identified as an event (803). For example, evaluation module 706 can determine that features 701 do not satisfy conditions to be identified as an event. That is, the one or more features of normalized signal 122B do not alone provide sufficient evidence of an event. In one aspect, one or more single source probabilities assigned to normalized signal 122B do not satisfy probability thresholds in thresholds 726.

Method 800 includes receiving a second signal (804). For example, event detection infrastructure 103 can receive normalized signal 122A. Method 800 includes deriving second one or more features of the second signal (805). For example, event detection infrastructure 103 can derive features 702 of normalized signal 122A. Features 702 can include and/or be derived from time 123A, location 124A, context 126A, content 127A, type 128A, and source 129A. Event detection infrastructure 103 can also derive features 702 from one or more single source probabilities assigned to normalized signal 122A.

Method 800 includes aggregating the first one or more features with the second one or more features into aggregated features (806). For example, evaluation module 706 can aggregate features 701 with features 702 into aggregated features 703. Evaluation module 706 can include an algorithm that defines and aggregates individual contributions of different signal features into aggregated features. Aggregating features 701 and 702 can include aggregating a single source probability assigned to normalized signal 122B for an event type with a signal source probability assigned to normalized signal 122A for the event type into a multisource probability for the event type.

Method 800 includes detecting an event from the aggregated features (807). For example, evaluation module 706 can determine that aggregated features 703 satisfy conditions to be detected as an event. Evaluation module 706 can detect event 724, such as, for example, a fire, an accident, a shooting, a protest, power outage, etc. based on satisfaction of the conditions.

In one aspect, conditions for event identification can be included in thresholds 726. Conditions can include threshold probabilities per event type. When a probability exceeds a threshold probability, evaluation module 706 can detect an event. A probability can be a single signal probability or a multisource (aggregated) probability. As such, evaluation module 706 can detect an event based on a multisource probability exceeding a probability threshold in thresholds 726.

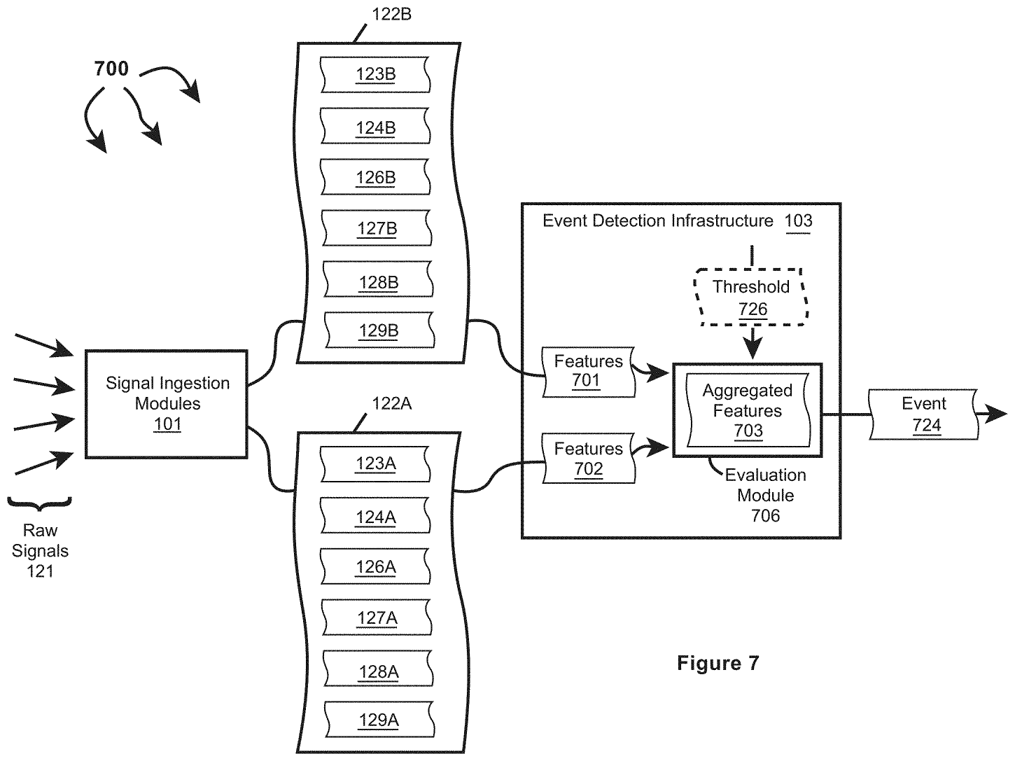

FIG. 9 illustrates an example computer architecture 900 that facilitates detecting an event from features derived from multiple signals. As depicted, event detection infrastructure 103 further includes evaluation module 706 and validator 904. Evaluation module 706 is configured to determine if features of a plurality of normalized signals indicate a possible event. Evaluation module 706 can detect (or not detect) a possible event based on one or more features of a normalized signal. Validator 904 is configured to validate (or not validate) a possible event as an actual event based on one or more features of another normalized signal.

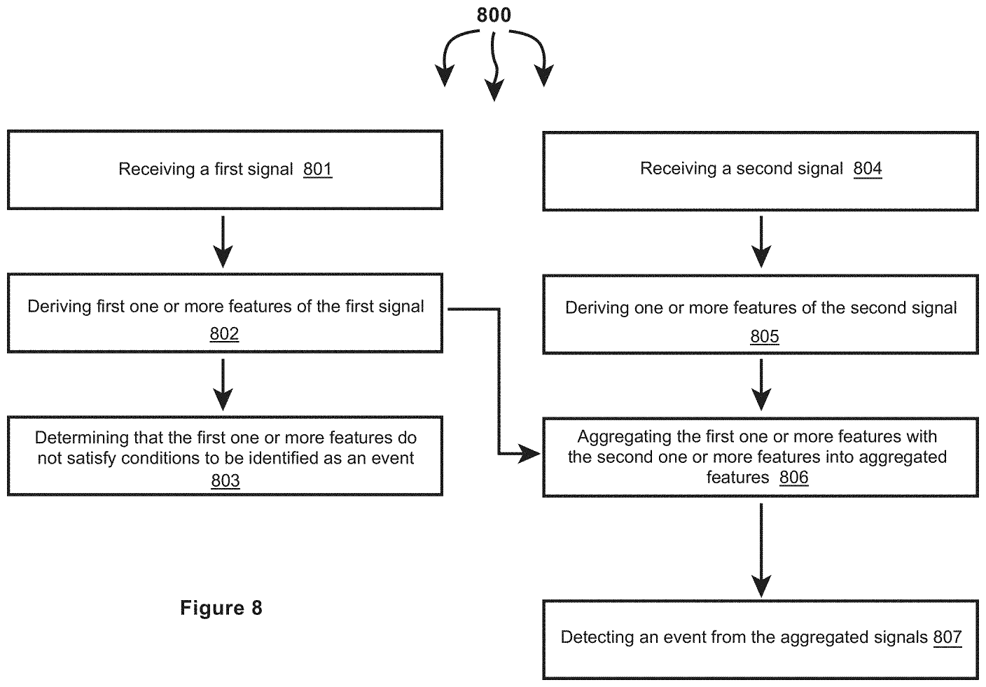

FIG. 10 illustrates a flow chart of an example method 1000 for detecting an event from features derived from multiple signals. Method 1000 will be described with respect to the components and data in computer architecture 1000.

Method 1000 includes receiving a first signal (1001). For example, event detection infrastructure 103 can receive normalized signal 122B. Method 1000 includes deriving first one or more features of the first signal (1002). For example, event detection infrastructure 103 can derive features 901 of normalized signal 122B. Features 901 can include and/or be derived from time 123B, location 124B, context 126B, content 127B, type 128B, and source 129B. Event detection infrastructure 103 can also derive features 901 from one or more single source probabilities assigned to normalized signal 122B.

Method 1000 includes detecting a possible event from the first one or more features (1003). For example, evaluation module 706 can detect possible event 923 from features 901. Based on features 901, event detection infrastructure 103 can determine that the evidence in features 901 is not confirming of an event but is sufficient to warrant further investigation of an event type. In one aspect, a single source probability assigned to normalized signal 122B for an event type does not satisfy a probability threshold for full event detection but does satisfy a probability threshold for further investigation.

Method 1000 includes receiving a second signal (1004). For example, event detection infrastructure 103 can receive normalized signal 122A. Method 1000 includes deriving second one or more features of the second signal (1005). For example, event detection infrastructure 103 can derive features 902 of normalized signal 122A. Features 902 can include and/or be derived from time 123A, location 124A, context 126A, content 127A, type 128A, and source 129A. Event detection infrastructure 103 can also derive features 902 from one or more single source probabilities assigned to normalized signal 122A.

Method 1000 includes validating the possible event as an actual event based on the second one or more features (1006). For example, validator 904 can determine that possible event 923 in combination with features 902 provide sufficient evidence of an actual event. Validator 904 can validate possible event 923 as event 924 based on features 902. In one aspect, validator 904 considers a single source probability assigned to normalized signal 122B in view of a single source probability assigned to normalized signal 122B. Validator 904 determines that the signal source probabilities, when considered collectively satisfy a probability threshold for detecting an event.

Forming and Detecting Events from Signal Groupings

In general, a plurality of normalized (e.g., TLC) signals can be grouped together in a signal group based on spatial similarity and/or temporal similarity among the plurality of normalized signals and/or corresponding raw (non-normalized) signals. A feature extractor can derive features (e.g., percentages, counts, durations, histograms, etc.) of the signal group from the plurality of normalized signals. An event detector can attempt to detect events from signal group features.

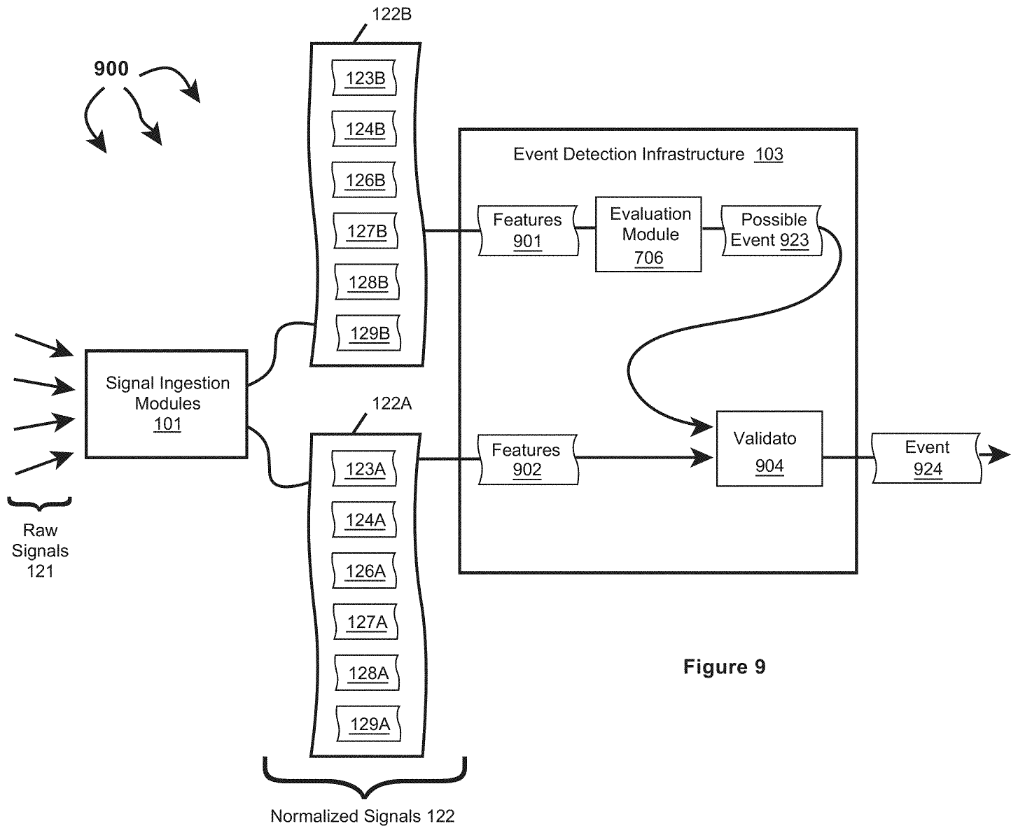

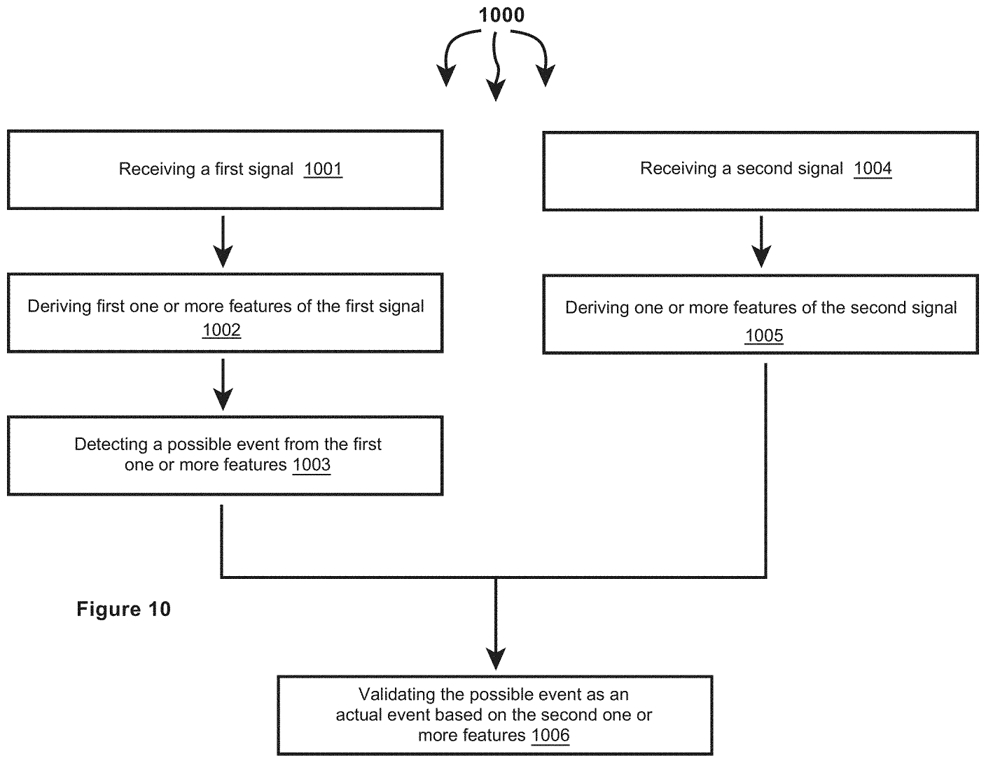

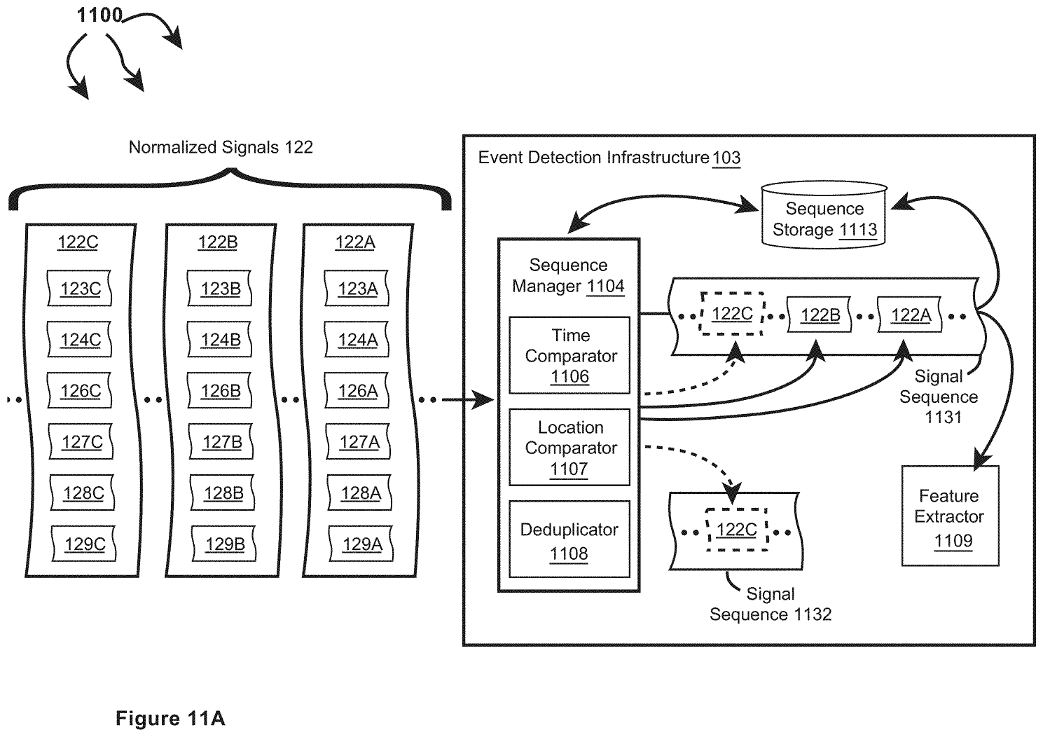

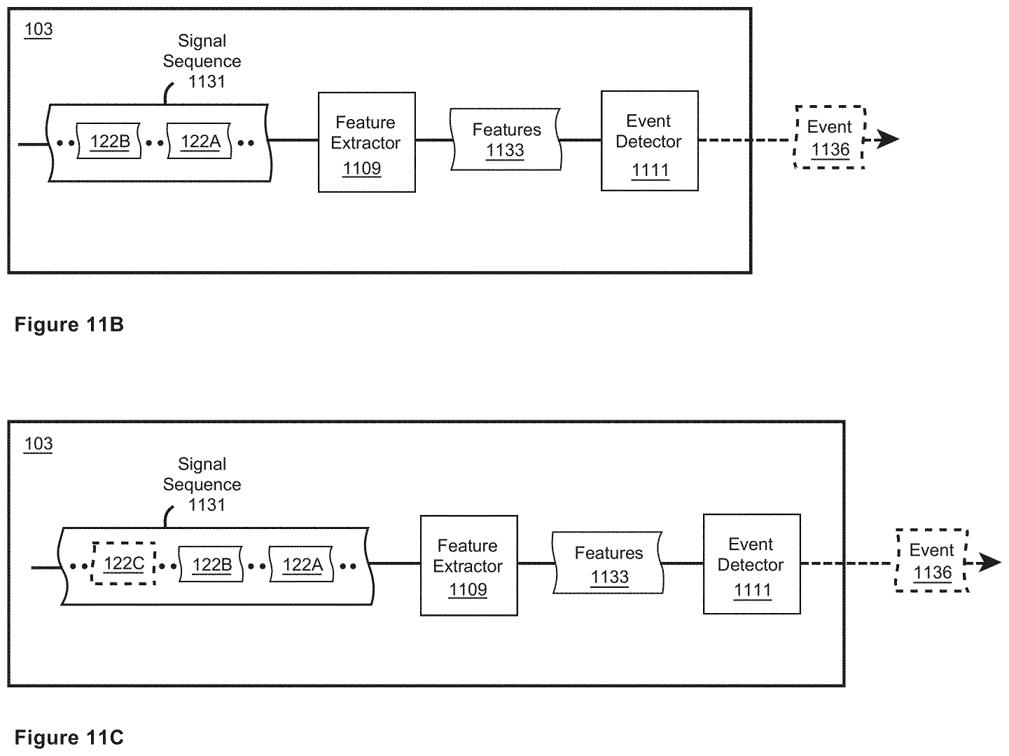

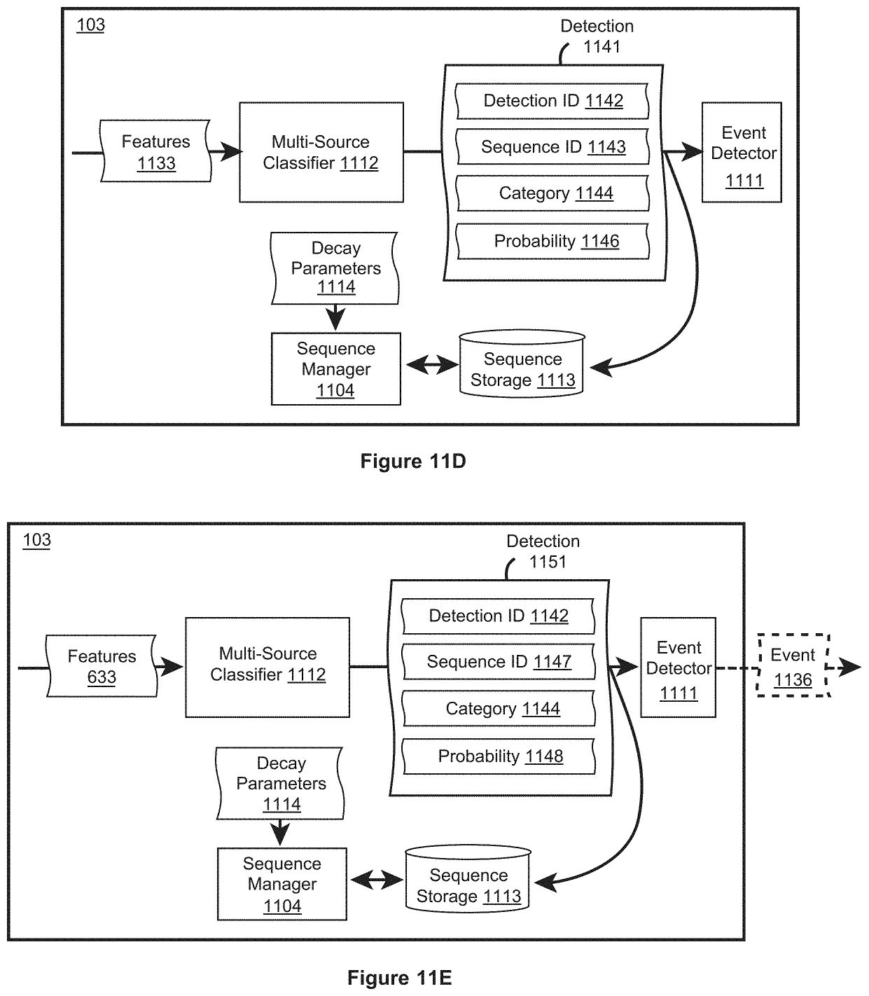

In one aspect, a plurality of normalized (e.g., TLC) signals are included in a signal sequence. FIG. 11A illustrates an example computer architecture 1100 that facilitates forming a signal sequence. Turning to FIG. 11A, event detection infrastructure 103 can include sequence manager 1104, feature extractor 1109, and sequence storage 1113. Sequence manager 1104 further includes time comparator 1106, location comparator 1107, and deduplicator 1108.

Time comparator 1106 is configured to determine temporal similarity between a normalized signal and a signal sequence. Time comparator 606 can compare a signal time of a received normalized signal to a time associated with existing signal sequences (e.g., the time of the first signal in the signal sequence). Temporal similarity can be defined by a specified time period, such as, for example, 5 minutes, 10 minutes, 20 minutes, 30 minutes, etc. When a normalized signal is received within the specified time period of a time associated with a signal sequence, the normalized signal can be considered temporally similar to signal sequence.

Likewise, location comparator 1107 is configured to determine spatial similarity between a normalized signal and a signal sequence. Location comparator 607 can compare a signal location of a received normalized signal to a location associated with existing signal sequences (e.g., the location of the first signal in the signal sequence). Spatial similarity can be defined by a geographic area, such as, for example, a distance radius (e.g., meters, miles, etc.), a number of geo cells of a specified precision, an Area of Interest (AoI), etc. When a normalized signal is received within the geographic area associated with a signal sequence, the normalized signal can be considered spatially similar to signal sequence.

Deduplicator 1108 is configured to determine if a signal is a duplicate of a previously received signal. Deduplicator 1108 can detect a duplicate when a normalized signal includes content (e.g., text, image, etc.) that is essentially identical to previously received content (previously received text, a previously received image, etc.). Deduplicator 608 can also detect a duplicate when a normalized signal is a repost or rebroadcast of a previously received normalized signal. Sequence manager 604 can ignore duplicate normalized signals.

Sequence manager 1104 can include a signal having sufficient temporal and spatial similarity to a signal sequence (and that is not a duplicate) in that signal sequence. Sequence manager 1104 can include a signal that lacks sufficient temporal and/or spatial similarity to any signal sequence (and that is not a duplicate) in a new signal sequence. A signal can be encoded into a signal sequence as a vector using any of a variety of algorithms including recurrent neural networks (RNN) (Long Short Term Memory (LSTM) networks and Gated Recurrent Units (GRUs)), convolutional neural networks, or other algorithms.

Feature extractor 1109 is configured to derive features of a signal sequence from signal data contained in the signal sequence. Derived features can include a percentage of normalized signals per geohash, a count of signals per time of day (hours:minutes), a signal gap histogram indicating a history of signal gap lengths (e.g., with bins for 1s, 5s, 10s, 1m, 5m, 10m, 30m), a count of signals per signal source, model output histograms indicating model scores, a sequent duration, count of signals per signal type, a number of unique users that posted social content, etc. However, feature extractor 1109 can derive a variety of other features as well. Additionally, the described features can be of different shapes to include more or less information, such as, for example, gap lengths, provider signal counts, histogram bins, sequence durations, category counts, etc.

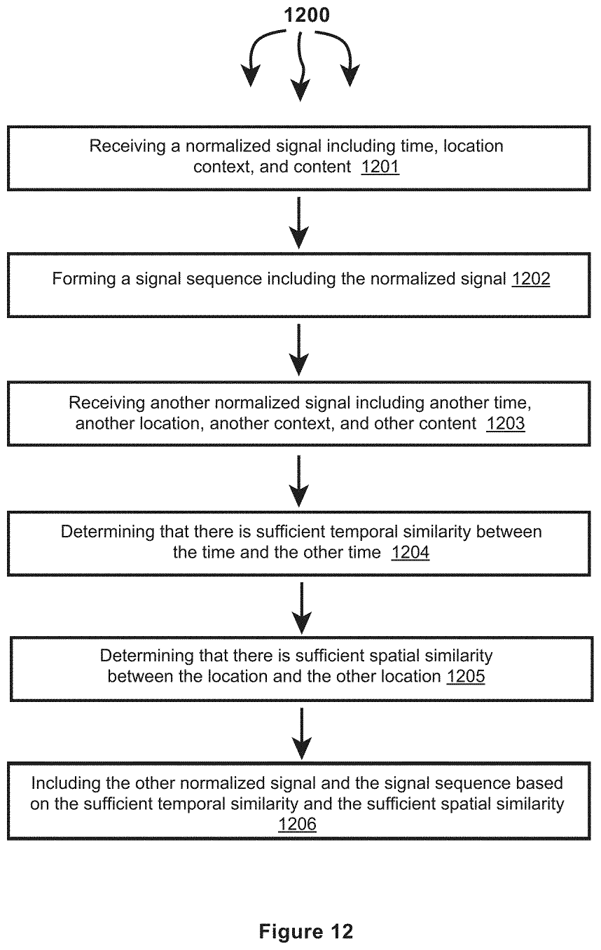

FIG. 12 illustrates a flow chart of an example method 1200 for forming a signal sequence. Method 1200 will be described with respect to the components and data in computer architecture 1100.

Method 1200 includes receiving a normalized signal including time, location, context, and content (1201). For example, sequence manager 1104 can receive normalized signal 122A. Method 1200 includes forming a signal sequence including the normalized signal (1202). For example, time comparator 1106 can compare time 123A to times associated with existing signal sequences. Similarly, location comparator 1107 can compare location 124A to locations associated with existing signal sequences. Time comparator 1106 and/or location comparator 1107 can determine that normalized signal 122A lacks sufficient temporal similarity and/or lacks sufficient spatial similarity respectively to existing signal sequences. Deduplicator 1108 can determine that normalized signal 122A is not a duplicate normalized signal. As such, sequence manager 1104 can form signal sequence 1131, include normalized signal 122A in signal sequence 1131, and store signal sequence 1131 in sequence storage 1113.

Method 1200 includes receiving another normalized signal including another time, another location, another context, and other content (1203). For example, sequence manager 1204 can receive normalized signal 122B.

Method 1200 includes determining that there is sufficient temporal similarity between the time and the other time (1204). For example, time comparator 1106 can compare time 123B to time 123A. Time comparator 1106 can determine that time 123B is sufficiently similar to time 123A. Method 1200 includes determining that there is sufficient spatial similarity between the location and the other location (1205). For example, location comparator 1107 can compare location 124B to location 124A. Location comparator 1107 can determine that location 124B has sufficient similarity to location 124A.

Method 1200 includes including the other normalized signal in the signal sequence based on the sufficient temporal similarity and the sufficient spatial similarity (1206). For example, sequence manager 1104 can include normalized signal 124B in signal sequence 1131 and update signal sequence 1131 in sequence storage 1113.

Subsequently, sequence manager 1104 can receive normalized signal 122C. Time comparator 1106 can compare time 123C to time 123A and location comparator 1107 can compare location 124C to location 124A. If there is sufficient temporal and spatial similarity between normalized signal 122C and normalized signal 122A, sequence manager 1104 can include normalized signal 122C in signal sequence 1131. On the other hand, if there is insufficient temporal similarity and/or insufficient spatial similarity between normalized signal 122C and normalized signal 122A, sequence manager 1104 can form signal sequence 1132. Sequence manager 1104 can include normalized signal 122C in signal sequence 1132 and store signal sequence 1132 in sequence storage 1113.

Turning to FIG. 11B, event detection infrastructure 103 further includes event detector 1111. Event detector 1111 is configured to determine if features extracted from a signal sequence are indicative of an event.

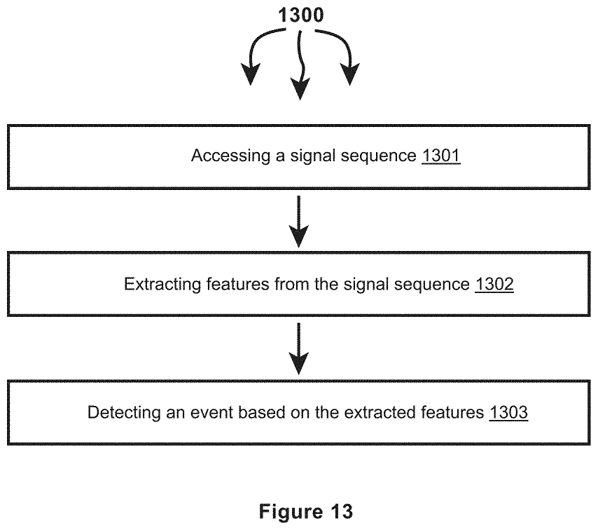

FIG. 13 illustrates a flow chart of an example method 1300 for detecting an event. Method 1300 will be described with respect to the components and data in computer architecture 1100.

Method 1300 includes accessing a signal sequence (1301). For example, feature extractor 1109 can access signal sequence 1131. Method 1300 includes extracting features from the signal sequence (1302). For example, feature extractor 1109 can extract features 1133 from signal sequence 1131. Method 1300 includes detecting an event based on the extracted features (1303). For example, event detector 1111 can attempt to detect an event from features 1133. In one aspect, event detector 1111 detects event 1136 from features 1133. In another aspect, event detector 1111 does not detect an event from features 1133.

Turning to FIG. 11C, sequence manager 1104 can subsequently add normalized signal 122C to signal sequence 1131 changing the signal data contained in signal sequence 1131. Feature extractor 1109 can again access signal sequence 1131. Feature extractor 1109 can derive features 1134 (which differ from features 133 at least due to inclusion of normalized signal 122C) from signal sequence 1131. Event detector 1111 can attempt to detect an event from features 1134. In one aspect, event detector 1111 detects event 1136 from features 1134. In another aspect, event detector 1111 does not detect an event from features 1134.

In a more specific aspect, event detector 1111 does not detect an event from features 1133. Subsequently, event detector 1111 detects event 1136 from features 1134.

An event detection can include one or more of a detection identifier, a sequence identifier, and an event type (e.g., accident, hazard, fire, traffic, weather, etc.).

A detection identifier can include a description and features. The description can be a hash of the signal with the earliest timestamp in a signal sequence. Features can include features of the signal sequence. Including features provides understanding of how a multisource detection evolves over time as normalized signals are added. A detection identifier can be shared by multiple detections derived from the same signal sequence.

A sequence identifier can include a description and features. The description can be a hash of all the signals included in the signal sequence. Features can include features of the signal sequence. Including features permits multisource detections to be linked to human event curations. A sequence identifier can be unique to a group of signals included in a signal sequence. When signals in a signal sequence change (e.g., when a new normalized signal is added), the sequence identifier is changed.

In one aspect, event detection infrastructure 103 also includes one or more multisource classifiers. Feature extractor 1109 can send extracted features to the one or more multisource classifiers. Per event type, the one or more multisource classifiers compute a probability (e.g., using artificial intelligence, machine learning, neural networks, etc.) that the extracted features indicate the type of event. Event detector 611 can detect (or not detect) an event from the computed probabilities.

For example, turning to FIG. 611D, multi-source classifier 1112 is configured to assign a probability that a signal sequence is a type of event. Multi-source classifier 1112 formulate a detection from signal sequence features. Multi-source classifier 1112 can implement any of a variety of algorithms including: logistic regression, random forest (RF), support vector machines (SVM), gradient boosting (GBDT), linear, regression, etc.

For example, multi-source classifier 1112 (e.g., using machine learning, artificial intelligence, neural networks, etc.) can formulate detection 1141 from features 1133. As depicted, detection 1141 includes detection ID 1142, sequence ID 1143, category 1144, and probability 1146. Detection 1141 can be forwarded to event detector 1111. Event detector 1111 can determine that probability 1146 does not satisfy a detection threshold for category 1144 to be indicated as an event. Detection 1141 can also be stored in sequence storage 1113.

Subsequently, turning to FIG. 11E, multi-source classifier 1112 (e.g., using machine learning, artificial intelligence, neural networks, etc.) can formulate detection 1151 from features 1134. As depicted, detection 1151 includes detection ID 1142, sequence ID 1147, category 1144, and probability 1148. Detection 1151 can be forwarded to event detector 1111. Event detector 1111 can determine that probability 1148 does satisfy a detection threshold for category 1144 to be indicated as an event. Detection 1141 can also be stored in sequence storage 1113. Event detector 1111 can output event 1136.

As detections age and are not determined to be accurate (i.e., are not True Positives), the probability declines that signals are “True Positive” detections of actual events. As such, a multi-source probability for a signal sequence, up to the last available signal, can be decayed over time. When a new signal comes in, the signal sequence can be extended by the new signal. The multi-source probability is recalculated for the new, extended signal sequence, and decay begins again.

In general, decay can also be calculated “ahead of time” when a detection is created and a probability assigned. By pre-calculating decay for future points in time, downstream systems do not have to perform calculations to update decayed probabilities. Further, different event classes can decay at different rates. For example, a fire detection can decay more slowly than a crash detection because these types of events tend to resolve at different speeds. If a new signal is added to update a sequence, the pre-calculated decay values may be discarded. A multi-source probability can be re-calculated for the updated sequence and new pre-calculated decay values can be assigned.

Multi-source probability decay can start after a specified period of time (e.g., 3 minutes) and decay can occur in accordance with a defined decay equation. Thus, modeling multi-source probability decay can include an initial static phase, a decay phase, and a final static phase. In one aspect, decay is initially more pronounced and then weakens. Thus, as a newer detection begins to age (e.g., by one minute) it is more indicative of a possible “false positive” relative to an older event that ages by an additional minute.

In one aspect, a decay equation defines exponential decay of multi-source probabilities. Different decay rates can be used for different classes. Decay can be similar to radioactive decay, with different tau values used to calculate the “half life” of multi-source probability for a class. Tau values can vary by event type.

In FIGS. 11D and 11E, decay for signal sequence 131 can be defined in decay parameters 1114. Sequence manager 104 can decay multisource probabilities computed for signal sequence 1133 in accordance with decay parameters 1114.

The components and data depicted in FIGS. 7-13 can be integrated with and/or can interoperate with one another to detect events. For example, evaluation module 706 and/or validator 904 can include and/or interoperate with one or more of: a sequence manager, a feature extractor, multi-source classifiers, or an event detector.

Creating Signal Sequences

There can be at least two steps in signal sequence creation: signal aggregation and sequence splitting. Aggregation can be a rough approximation of what signals “might be” related. In one aspect, a first signal is compared to a second signal across one or more of: a Time dimension, a Location dimension, and a Context dimension to compute a signal similarity. If the signal similarity satisfies a first similarity threshold, the first signal and the second signal can be aggregated into the same (and potentially already existing) signal sequence. If the signal similarity does not satisfy the similarity threshold, the first signal and the second signal are not aggregated.

Sequence splitting can be a more intelligent activity to ensure sequences include signals that are “more likely” to be related. Sequence splitting can include comparing signals in a signal sequence to one another or comparing a signal in a signal sequence to characteristics of the signal sequence.

In one aspect, a first signal in a signal sequence is compared to a second signal in the signal sequence across one or more of: a Time dimension, a Location dimension, and a Context dimension to compute another signal similarity. If the other signal similarity satisfies a second similarity threshold, the first signal and the second signal can be retained in the signal sequence. If the other signal similarity does not satisfy the second similarity threshold, one of the first signal or the second signal can be split into a new signal sequence or split to another signal sequence.

In another aspect, the first signal is compared to characteristics of the signal sequence to compute the other signal similarity. If the other signal similarity satisfies the second similarity threshold, the first signal can be retained in the signal sequence. If the other signal similarity does not satisfy the second similarity threshold, the first signal can be split into a new signal sequence or split to another signal sequence.

The first similarly threshold can be less stringent than the second similarity threshold.

Aggregation and signal splitting can operate independently of one another. For example, sequence splitting can be performed on any signal sequence, even signal sequences not formed using aggregation. Likewise, signals may be aggregated into a signal sequence without subsequently implementing sequence splitting on the signal sequence.

Signal Aggregation

In general, sequence manager 1104 can aggregate signal sequences. In aspects, sequence manager 1104 aggregates signals in real-time (e.g., in accordance with method 1200 or similar methods). Sets of aggregated signals can be viewed as “sequences” (i.e., a collection of signals). As described, detections can be formed from sequences. Detections can be sequences with corresponding metadata (probability, severity, location, etc.).

An event detection infrastructure (e.g., 103) can be continually attempting to determine “what is happening in the world, where is it happening, and when is it happening.” Signal ingestion modules (e.g., 101) can ingest hundreds, thousands, millions or even billions of signals every day in real-time and index them by location, time and context. Each of those dimensions can be handled as follows:
Location: Convert signals with geo (point, line, polygon, etc.) into a set of geohashes
Time: Convert signals time of incident into various time buckets (30 minutes, 60 minutes, 120 minutes)
Context: Convert signals context (active shooter, animal response, structure fire) into an overall context bucket (fire, police activity, threat)

The result is a database of signals (being constantly updated) representing information known about what is happening in the world at a given point. A portion of the database associated with an area can be represented as a three-dimensional geo cell (e.g., geohash) heat map (or grid image) for an area (e.g., city). The three-dimensional heat map (or grid image) depicts the intuition of what the database looks like for the area. A color and a height can be associated with each geo cell and correspondingly represented in the heatmap for each geo cell. One color (e.g., green) can represent the absence of any signals in the geo cell. Another color (e.g., red) can represent a higher signal volume. One or more other colors can represent intermediate signal volumes between the absence of any signals and a higher volume of signals. For example, yellow can represent a lower signal volume and orange can represent a moderate signal volume (i.e., more than a lower signal volume but less than a higher signal volume). Other volume indicators, volume thresholds, volume gradients, etc. can also be visually represented.

A height can indicated a relative volume of signals. A greater height depicted for a geo cell can represent a relatively higher signal volume signal for the geo cell (even for geo cells represented by the same color). A lower height depicted for a geo cell can represent a relatively lower signal volume (even for geo cells represented by the same color).

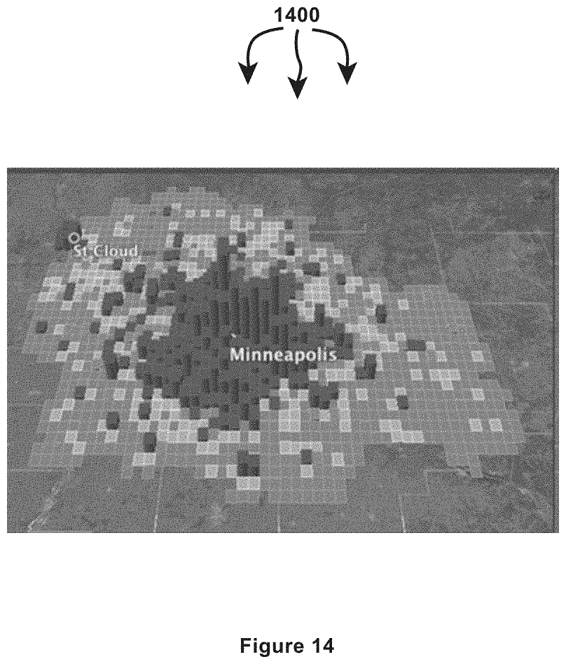

FIG. 14 illustrates an example three-dimensional heat map representation 1400 of a geo cell database portion.

Generally, a signal is a piece of evidence. As described, a signal can be anything from a social media post to a CAD call to a frame from a live video feed. Signals that can be continuous in one or more dimensions (time, geo, context) can be indexes into a TLC signal space.

In general, a sequence is a collection of signals (e.g., 1131, 1132, etc.).

When a new signal is ingested, a signal “trigger” can be created. A signal trigger represents an evidence request to find evidence in a particular slice of (location/time/context) space. The evidence request can have varying levels of specificity. One way to view a trigger is as a (e.g., emergency response) dispatcher receiving messages and trying to understand what is happening in an area, such as, for example:
We got a report of a shooting happening at the Walmart, have there been any other reports about a shooting there in the past hour? (More specific)
We got a report of something happening downtown, have we heard anything else? (Less specific)

Below is example trigger code for a trigger. The trigger has location, time, context. The trigger also has a nature, guid (for identification) and sequence keys indicating where to search for information.

{“timestamp”: 1566391375, “geohash”: dp3jyc”,
“classification_tag_name”: “Traffic”, “guid”: “55c2b3a6-7ce9-371a-b81c-
bc533eeb8faa”, “nature_name”: “TRAFFIC”, “sequence_keys”:
[{“geohash”: “dp3jyc”, “classification_tag_name”: “Traffic”, “timestamp”:
1566391375, “query_key”: “dp3jyc|2019:21:12|Traffic”}, “geohash”:
“dp3jyc”, “classification_tag_name”: “Traffic”, “timestamp”:
1566394975.0, “query_key”: “dp3jyc|2019:21:13|Traffic”}]}

A signal trigger can find its own creator signal or its creator signal and other signals, depending on what evidence has been received. When a computed similarity (by sequence manager 1104) from comparing a signal trigger and a signal satisfy a first similarity threshold. For example, sequence manager 1104 can compute that similarity between 122A, 122B, and 122C and corresponding signal triggers satisfy the first similarity threshold as signals 122A, 122B, 122C, etc. are received.

Signal Sequence Splitting

Subsequent to signal aggregation, sequences can be considered for signal splitting. Signal splitting helps ensure that aggregated signals are not actually multiple separate incidents. For example, two fire signals in Los Angeles might be aggregated together into the same sequence but actually represent two separate fires that just happen to be in the same time and area. Sequence splitting can include performing more detailed signal analysis using additional intelligence, such as, machine learning, artificial intelligence, neural networks, logic, heuristics etc., to make decisions. Input to sequence splitting can be a signal sequence. Output can be the input sequence or multiple sequences (if splits were made). A split sequence can be marked with the sequence id of its parent sequence. Marking with a parent sequence can be helpful for tracking and debugging.

Sequence splitting logic can include at least two activities:
A. Split by Context. Signals that aren't likely to be related but fall under the same context (C) can be split apart. For example, grass fires and apartment fires don't usually go together and can be split. Exceptions can be made if the signals are within a threshold distance of each other (time and/or space). For example, if a grass fire caught a nearby apartment building on fire or vice versa.
B. Split by Distance. Signals a threshold distance apart from each other in space (L) and/or time ( ). Parameters can be used for whether signals are in a major city or not and depending on which tag is being considered.

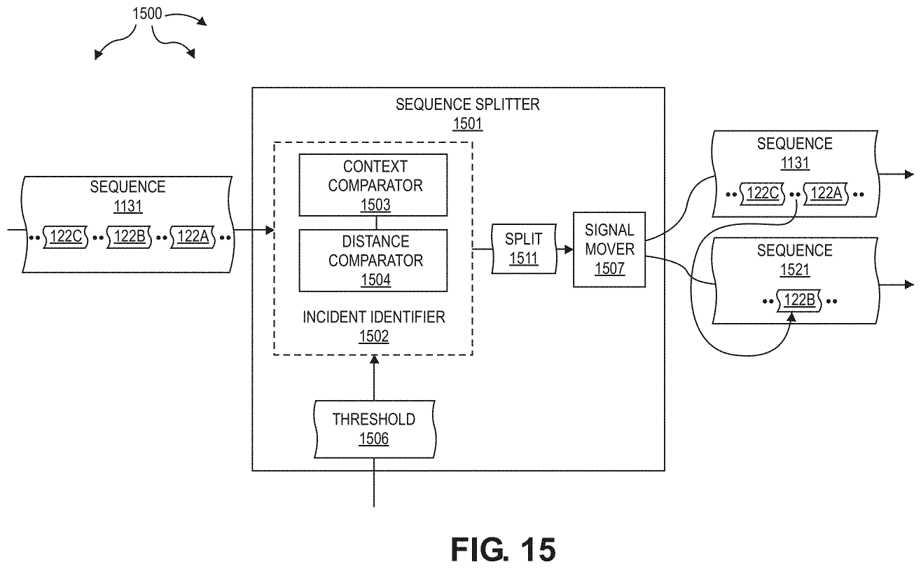

FIG. 15 illustrates a computer architecture 1500 that facilitates splitting signal sequences. As depicted, computer architecture 1500 includes sequence splitter 1501. Sequence splitter 1501 further includes incident identifier 1502 and signal mover 1507. Incident identifier 1503 further includes context comparator 1503 and distance comparator 1504.

In general, sequence splitter 1501 receives a signal sequence and determines if any signals in the signal sequence are to be split into a new signal sequence or into a different existing signal sequence. Context comparator 1503 can compare signal contexts to determine similarity between the signal contexts. Distance comparator 1504 can compare signal distances (both space (L) and time (T)) to determine distances between signals. In view of context similarity and distance, incident identifier can determine if similarity between two signals satisfies threshold 1506 (e.g., a second threshold).

When threshold 1506 is satisfied, incident identifier 1502 determines that the signals are related to the same incident. As such, incident identifier 1502 does not move any signals to another signal sequence. On the other hand, when threshold 1506 is not satisfied, incident identifier 1502 determines that the signals are related to different incidents. In response, incident identifier 1502 can send a split command to signal mover 1507. The split command can instruction signal mover 1507 to move a signal from one signal sequence to another (and possibly new) signal sequence.

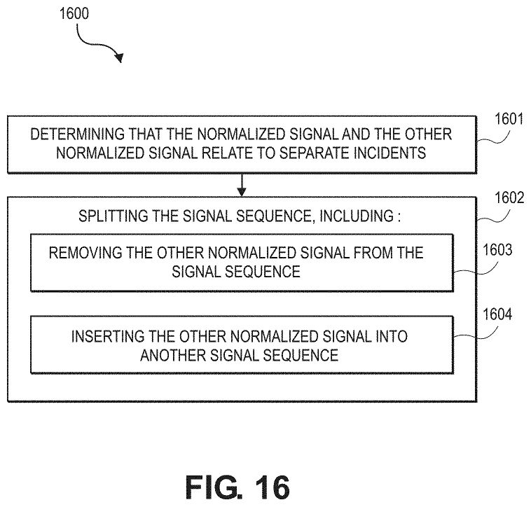

FIG. 16 illustrates a flow chart of an example method 1600 for splitting a signal sequence. The method 1600 will be described with respect to the components and data in computer architecture 1500.

Method 1600 can include receiving a signal sequence. For example, sequence splitter 1501 can receive sequence 1131. Method 1600 can include accessing a normalized signal and another normalized signal from the signal sequence. For example, incident identifier 1502 can access normalized signals 122A and 122B from within signal sequence 1131.

Method 1600 includes determining that the normalized signal and the other normalized signal relate to separate incidents (1601). For example, context comparator 1503 can determine context similarity between contexts of normalized signal 122A and normalized signal 122B. Distance comparator 1504 can determine a signal distance (in space (L) and/or time (T)) between normalized signal 122A and normalized signal 112B. Incident identifier 1502 can determine that the similarity between normalized signal 122A and normalized signal 122B does not satisfy threshold 1506 in view of the context similarity of and/or distance between normalized signal 122A and normalized signal 122B. Based at least in part on failure to satisfy threshold 1506, incident identifier can determine that normalized signal 122A and normalized signal 122B relate to separate incidents.

Method 1600 includes splitting the signal sequence (1602). For example, in view of determining that normalized signal 122A and normalized signal 122B relate to separate incidents, incident identifier can formulate split command 1511. Split command 1511 can instruct signal mover 1507 to move normalized signal 122B from sequence 1131 to sequence 1521. Signal mover 1507 can receive split command 1511 from incident identifier 1502.

Method 1600 includes removing the other normalized signal from the signal sequence (1603). Method 1600 includes inserting the other normalized signal into another signal sequence (1604). For example, signal mover 1507 can remove normalized signal 122B from sequence 1131 and signal mover 1507 can add normalized signal 122B to sequence 1521.

Event detection infrastructure 103 can utilize sequence 1131 to detect an event. Event detection infrastructure 103 can utilize sequence 1521 to detect another (different) event.

Major Events

Multisource event detection systems (e.g., as described with respect to computer architecture 100) can detect shorter term events, such as, for example, events lasting seconds, minutes, or hours, from various ingested digital signals. Accidents, power outages, shootings, minor fires, etc. can be considered shorter term events. However, there are other events, such as, for example, hurricanes, major wildfires, etc. that may last days/weeks. These longer-term events (which may be referred to as “major events”) are different than shorter term events. For example, longer term events can completely change a geographic area. Under those circumstances, there can be (relatively drastic) shifts in the volume and type of generated digital signals. Generated digital signals can primarily relate to and be informed by the major event. Also, information desirable by customers/partners can be (possibly drastically) different during a major event than information desirable during a shorter-term event.

In general, an approach for detecting and handling major events is to provide a “zoomed in” view of the major events. A “zoomed in” view can support customers/partners by providing detailed situational awareness about the major event, for example, customers, clients, partners, etc. Partners can include those working to get a situation associated with a major event under control (e.g., fire fighters, emergency management personnel, etc.)

Multisource event detection systems can identify (detect) major events and also detect shorter term events within (e.g., a context of) identified (detected) major events. Major events can be identified (detected) as anomalies via their characteristics, including Signal Volume, Signal Diversity, Severity, Content, Historical Events, etc. In some aspects, severity may prove optimally reliable in detecting major events. Offline analysis of historical events and human feedback may also be used to reliably detect major events.

As a multisource event detection system is detecting events in real time, separate data stores of Historical event information and Current potential major events can be maintained.

There may also be ripple effects beyond the immediate area. For example, a major wildfire in Northern California may directly cause additional events in Southern California (e.g., ash/smoke). Indirectly, major events may also seem to increase the likelihood of similar events happening throughout other geographic regions. For example, a major shooting seems to embolden potential copycat events or related events. After the El Paso shooting a man walked into a Wal-Mart store fully armed to test his 2nd amendment rights and subsequently caused a mass panic and evacuation. Major shootings also put people on high alert. Again, after the El Paso shooting the sound of a motorcycle backfiring caused a mass panic and stampede in Times Square. Thus, the dynamics of understanding major events and detecting corresponding ripple effects over large spatio-temporal areas are relatively complex.

In general, a multisource event detection system (e.g., as described with respect to computer architecture 100) can facilitate at least two activities related to major events. The multisource event detection system can consider major events with a finer grained analysis and situational awareness (e.g., relative to other, for example, shorter term events). As such, the multisource event detection system can provide additional context to partners/customers. For example, there may be at least some disruption anytime a tree falls into a roadway. However, during a hurricane a fallen tree may block the only route to a stranded person. In normal times (i.e., when no major events are relevant to a time and/or location), the multisource event detection system may perform some analysis of various shorter-term events. However, when a major (longer-term) event is relevant to a time and location, the multisource event detection system can perform more significant, more detailed, and finer grained analysis on other shorter-term events at or near the time and location of the major event.

Additionally, a multisource event detection system can use knowledge of ongoing major events to inform other detections in an immediate area as well as other larger geographic areas (e.g., an entire country).

A computer architecture for handling major events can include a variety of interoperating components integrated into a larger multi-source event detection system. The interoperating components can identify major events, detect other shorter-term events within major events, determine immediate area (time and location) dynamics, determine ripple effects beyond the immediate area.

Major Event Identification

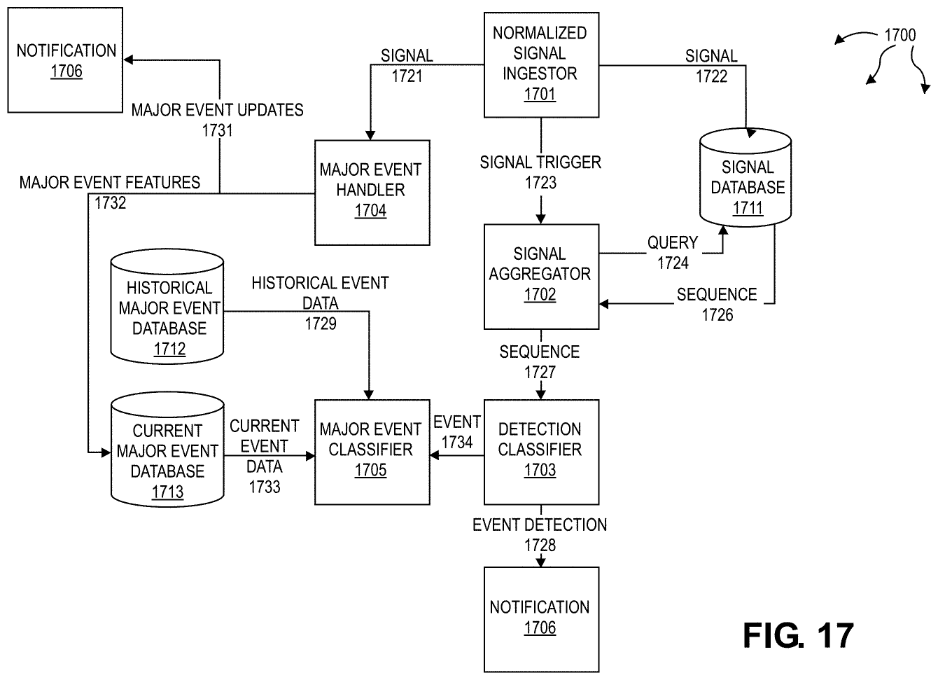

FIG. 17 illustrates a computer architecture 1700 that facilitates identifying major events. As depicted, computer architecture 1700 includes normalized signal ingestor 1701, signal aggregator 1702, detection classifier 1703, major event handler 1704, major event classifier 1705, notification 1706, signal database 1711, historical major event database 1712, and current major event database 1713.

In one aspect, one or more of: normalized signal ingestor 1701, signal aggregator 1702, detection classifier 1703, notification 1706, major event handler 1704, and major event classifier 1705 are included in (or incorporated into) and/or integrated with and/or interoperate with other components of event detection infrastructure 103.

In one aspect, normalized signal ingestor 1701 accepts normalized signals (e.g., 122) from signal ingestion modules 101 that include time, location, and context dimensions. Normalized signal ingestor 1701 can send normalized signals 1721 to major event handler 1704 and can send normalized signals 1722 to signal database 1711. Normalized signal ingestor 1701 can also send signal trigger 1723 to signal aggregator 1702.

In response to signal trigger 1723, signal aggregator 1702 can query 1724 signal database 1711 for a signal sequence relevant to signal trigger 1723. In response, signal database 1711 can return sequence 1726 to signal aggregator 1702. Signal aggregator 1702 can forward signal sequence 1727 to detection classifier 1703. In one aspect, signal aggregator implements one or more signal sequence aggregation and/or signal sequence splitting activities (as described with respect to sequence manager 1104 and sequence splitter 1501) to transform signal sequence 1726 into signal sequence 1727. In one aspect, signal database 1711 is similar to geo cell database 111 and/or similar to sequence storage 1113.

Detection classifier 1703 can be a signal source or multi-source classifier as described (and may include and/or interoperate with and/or be integrated into functionality from evaluation module 706, validator 904, event detector 1111, etc.). Detection classifier 1703 can detect event 1734 from sequence 1727. In response to event detection, detection classifier 1703 can send event detection 1728 (including event 1734) to notification 1706 (which may be may include and/or interoperate with and/or be integrated into event notification 116). Detection classifier 1703 can also send event 1734 to major event classifier 1705.

Major event classifier 1705 can access historical event data 1729 from historical major event database 1712. Major event classifier 1705 can also access current event data from current major event database. Major event classifier 1705 can compare event 1734 to historical event data 1729 and/or current event data 1733 to determine if event 1734 is or is associated with a major event.

In one aspect major event classifier 1705 uses anomaly detection to identify events that are considered “major”. Considering an event “major” can depend on a context of the area/time in which the event occurs. A crash can be considered a major event if it blocks the only highway between two cities. Likewise, a shooting can be a major event if it is at/nearby an area with a lot of people. Anomaly detection can include a multi-source event detection system “comparing” a current event to past detected events in the same area. In one aspect,

As described, FIG. 14 illustrates an example three-dimensional heatmap representation 14000 of a geo cell database portion. Per geohash (and possibly based in information started in geo cell database 111), a multi-source event detection system (e.g., event detection infrastructure 103) can store (possible every) prior detected events. Each historical event can include a variety of information (severity of the event, the signals collected, etc.). Data can be stratified by time, geo, classification tag buckets, etc.

Thus, when an event type (e.g., accident) is detected, the multi-source event detection system does a query to find all past events of the same type (e.g., prior accidents) within different time intervals (same day of week, same month of year, same hour of day, etc.). Various comparisons can be made between the detected event and past events.

Event data can be stored at different levels of granularity. At a higher granularity level, event data can include counts by geohash, hour, classification tag. At a lower granularity level, the entirety of the events can be stored (including some or all of their metadata).

Thus, when an event is detected, various information can be accessed for prior events (and, for example, included in historical event data 1729 and/or current event data 1733), including:
Historical Events at that geohash
   High level count summary data: geohash/hour/classification tag counts
   Low level event data:
      Events at same hour, previous 7 days
      Events at same hour, same, day, previous 4 weeks
      Events at same hour, same day, same, week, previous 12 months
      Events at same hour/day, last years
Current Detected Event Data
   Signal Volume
   Signal Diversity
   Signal Content
   Detection Severity
Geohash Location Features
   Entities
      Schools
      Businesses
      Natural Features (forest, ocean, etc)
      Roads
      Etc
Currently Nearby Events
   Neighboring geohashes, 3 hour window

Some or all of the prior event information can be used to determine whether a current event (e.g., event 1734) is an anomaly. In some aspects, an event is classified as “close to” (or potentially) an anomaly. Events that are “close to” an anomaly, can be stored and reviewed periodically to determine if classification as an anomaly is appropriate based on the sufficiency of further information. Classifying an event as a “near anomaly” may be appropriate when there the initial number of signals is insufficient and there is not enough information to make a reliable determination. “Near anomalies” are also useful for review to update models for future use.

Major event handler can provide major event updates 1731 to notification 1706 as other signals relevant to a major event are ingested. Major event handler 1704 can also store major event features 1732 in current major event database 1713.

Event Detection within Major Events

When an event is classified as an anomaly, and thus a “Major Event”, the multi-source event detection (e.g., event detection infrastructure 103) can treat the associated area differently.
1. The event is marked as “Major Event” in an event database and polygon is selected for monitoring based on the event type (we monitor a larger area for fires compared to traffic for example)
2. The Major Event is tagged with a “cool down” timestamp. When a new signal is received for this event the cool down timestamp is reset (an event can be kept alive for as long as new signals are received).
3. The multi-source vent detection system can listen more closely for signals in this event.
4. Signals originating within the polygon become part of the Major Event and update the event appropriately.
5. Nearby events are periodically checked to see if they should be merged into the Major Event
6. Nearby entities affected by the major event (schools, etc.) are marked
7. The Major Event's geo is adjusted (expanding, contracting) as needed.

Immediate Area Dynamics

An immediate area of the Major Event is defined as a buffer area around the Major Event's polygon. This buffer can be (possibly much) larger. Monitoring the buffer (in addition to the polygon) can facilitate determining how the Major Event is disrupting a nearby region. This includes incidents like smoke from a fire drifting to nearby cities or re-routed cars from an accident causing congestion. In one aspect, the buffer area is marked as another polygon. Any new detections that fall into the buffer area are checked to see whether or not the detections are possibly related to the Major Event. Smoke events are deemed to be possibly related to a nearby fire event. Likewise, traffic is deemed to be possibly related to nearby other accident events.

Being able to identify these nearby events allows us to:
1. Link the nearby events to the nearby Major Event to be able provide better context
2. Monitor how nearby events evolve so that we can have a better understanding of the dynamics

Ripple Effects Beyond the Immediate Area

Major Events can cause a ripple effect through a much larger area/time (potentially through an entire country). One ripple effect is that the existence of a Major Event makes other small and large events more likely. This is true for natural reasons and for human reasons. On the natural side, an earthquake leads to aftershocks, other earthquakes, tsunamis, power outages, evacuations etc. These other events can be outside the immediate area of the major event. On the human side, there can be copy cat events for shootings, fires, and weird psychological effects like that if you see a major car crash on the news you are more likely to get into a car crash yourself. For natural ripple effects, the multi-source detection system can listen more closely to be able to understand and detect the events.

Human ripple effects can include increased volumes of signals that falsely report an event. There may also be increased volumes of social signals comment on the major event. Some examples include:
1. Notre Dame (Paris) Fire: Police got calls from people asking about the Notre Dame University Fire
2. El Paso Shooting: People all over the country were talking about the shooting. They use present tense and tag themselves at other places in the country.
3. Hurricane Dorian: People posted pictures/videos of previous hurricanes (Sandy, Katrina)
4. 9/11: Every year on September 11 th people post pictures+videos of the towers getting shot down. Again they use present tense and tag themselves in NYC

To handle human ripple effects a Region can be Locked. Essentially, when a major event is detected, descriptive features about the event (location, time, classification of event, important entity names) as well as some representative content (images, audio, video, text) are stored. When other events/detections in areas outside of the Major Event area (e.g., including buffer) are received, the multi-source event detection system can compare the detected event to major event descriptive features to see if they match any of the ongoing major events.

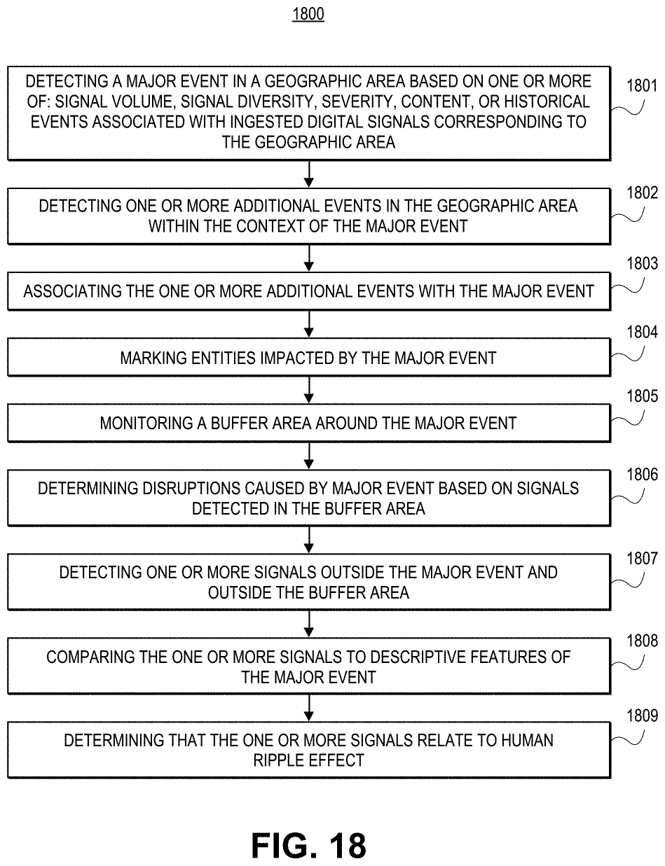

FIG. 18 illustrates a flow chart of an example method 1800 for detecting human ripple effect. Method 1800 will be described with respect to components and data of computer architecture 100 and computer architecture 1700.

Method 1800 includes detecting a major event in a geographic area based on one or more of: signal volume, signal diversity, severity, content, or historical events associated with ingested digital signals corresponding to the geographic area (1801). For example, detection classifier 1703 can detect event 1734 in a geographic region from signal sequence 1727. Major event classifier 1705 can classify detected event 1734 as a major event.

Method 1700 incudes detecting one or more additional events in the geographic area within the context of the major event (1802). For example, detection classifier 1803 can detect one or more events in the geographic region within the context of (major) event 1734. Method 1700 includes associating the one or more additional events with the major event (1803). For example, detection classifier 1703 and/or major event classifier 1705 can associate the one or more events with (major) event 1734. Detection classifier 1703 and/or major event classifier 1705 can perform more significant, more detailed, and finer grained analysis on shorter-term events at or near the time and location of the (major) event 1734 (relative to processing shorter-term events in absence of (major) event 1734).

Method 1800 includes marking entities impacted by the major event (1804). For example, event detection infrastructure 103 and/or major event handler 104 can mark entities, such as, for example, schools, businesses, hospitals, sub-stations, AIs, streets, etc. as impacted by (major) event 1734. Method 1800 includes monitoring a buffer area around the major event (1805). For example, event detection infrastructure 103 and/or major event handler can monitor a buffer (e.g., a distance) around (major) event 1734.

Method 1800 includes determining disruptions caused by major event based on signals detected in the buffer area (1806). For example, event detection infrastructure 103 and/or major event handler 1705 can determine disruptions cause by (major) event 1734 based on signals in the buffer area. Method 1800 includes detecting one or more signals outside the major event and outside the buffer area (1807). For example, event detection infrastructure 103 and/or major event handler 1705 can access one or more signals that are both outside (major) event 1734 and outside the buffer around (major) event 1734.

Method 1800 includes comparing the one or more signals to descriptive features of the major event (1808). For example, event detection infrastructure 103 and/or major event handler 1705 can compare the one or more signals to descriptive features of (major) event 1734. Method 1800 includes determining that the one or more signals relate to human ripple effect (1809). For example, event detection infrastructure 103 and/or major event handler 1705 can determine that the one or more signals related to human ripple effect.

Event detection infrastructure 103 and/or major event handler 1705 can apply additional scrutiny to the one or more signals based on (major) event 1734 occurring. The additional scrutiny can be more scrutiny than event detection infrastructure 103 and/or major event handler 1705 would otherwise apply in absence of a previously detected major event. Additional scrutiny can include more significant, more detailed, and finer grained analysis on other shorter-term events based on the time and location of (major) event 1734.

When signals relate to human ripple effect, event detection infrastructure 103 and/or major event handler 1705 may not associated the signals with (major) event 1734. When signals relate to human ripple effect, event detection infrastructure 103 and/or major event handler 1705 can notify entities outside of the buffer area that the signals are related to human ripple effect (and thus have a reduced likelihood of association with (major) event 1734.

Signal Filtering During Major Events

Signal volume of less relevant, and possibly irrelevant signals, (including, and possibly primarily, social media signals) can rise (possibly significantly) following major events, such as, wildfires, shootings, natural disasters, terror attacks, etc. Commentary about a major event can inundate detection models, which can slow down curation and/or possibly result in abundant false positives.

As such, an intermittently deployable filter can be used to quell increased volumes of less relevant signals in the wake of a major event, without significant negative impact on new event detection and validation.

For example, upon detection of a major event, an ad hoc, event-specific, filter can be generated and implemented. A relatively small number of (e.g., text) signals related to the major event can be used to gather information needed to set rejection criteria in the ad hoc major incident filter. Once the major event related commentary has subsided, the ad hoc filter can be disabled, and the normal detection flow (re)enabled.

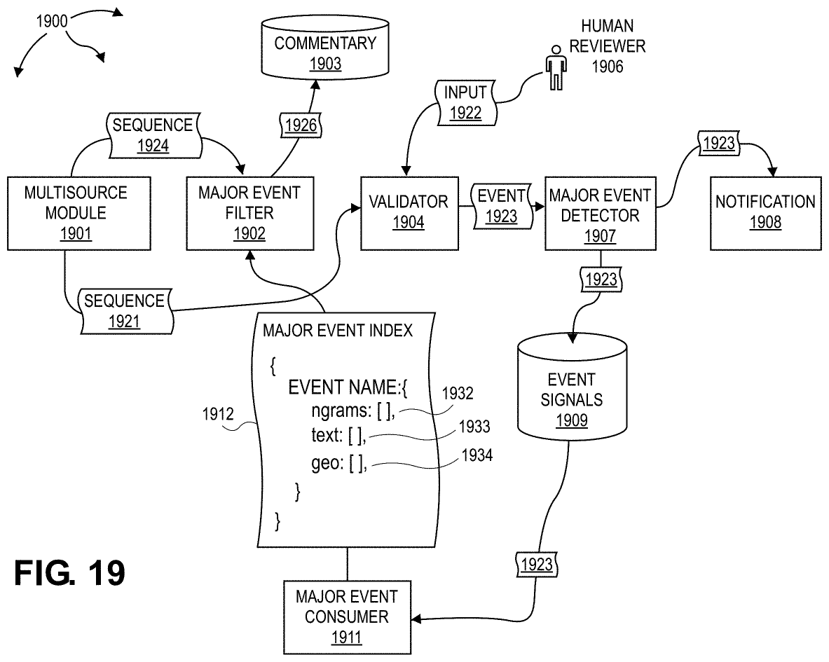

FIG. 19 illustrates a computer architecture 1900 that facilitates filtering signals during major events. As depicted, computer architecture includes multisource module 1901, major event filter 1902, commentary 1903, validator 1904, human reviewer 1904, notification 1908, event signals 1909, and major event consumer 1911. Major event filter 1902 can be an intermittently deployable (and potentially event-specific) filter.

One or more digital signals can be received (ingested) at multisource module 1901. Multisource module 1901 can include functionality similar to and/or be integrated into and/or interoperate with signal ingestion modules (e.g., including in signal ingestion modules 101) and/or event detection modules (e.g., including in event detection infrastructure 103).

As described, signal ingestion modules can ingest a variety of raw structured and/or unstructured signals on an ongoing basis and in essentially real-time. Raw signals can include social posts, live broadcasts, traffic camera feeds, other camera feeds (e.g., from other public cameras or from CCTV cameras), listening device feeds, 911 calls, weather data, planned events, IoT device data, crowd sourced traffic and road information, satellite data, air quality sensor data, smart city sensor data, public radio communication (e.g., among first responders and/or dispatchers, between air traffic controllers and pilots), etc. The content of raw signals can include images, video, audio, text, etc. Generally, the signal ingestion modules normalize raw signals into normalized signals, for example, having a Time, Location, Context (or “TLC”) format.

Multisource module 1901 can used different types of ingested signals (e.g., social media signals, web signals, and streaming signals) to identify events. Different types of signals can include different data types and different data formats. Data types can include audio, video, image, and text. Different formats can include text in XML, text in JavaScript Object Notation (JSON), text in RSS feed, plain text, video stream in Dynamic Adaptive Streaming over HTTP (DASH), video stream in HTTP Live Streaming (HLS), video stream in Real-Time Messaging Protocol (RTMP), etc.

Detection sequences can bypass major event filter 1902 or major event filter 1902 can be otherwise removed from an event detection flow in absence of a major event detection. When a major event is detected, content from the major event detection can be routed to event signals 1909 (e.g., a kafka topic). Major event consumer 1911 can extract event-specific ngrams, text, and geo from collected event signals in event signals 1909. Major event consumer 1911 can compare the event-specific ngrams to ngrams from a random sample/plurality (e.g., ˜10,000) typical posts from a corresponding major event classification category.

Major event consumer 1911 can create an array of geocells affected by the major incident and possible also including (e.g., nearest) neighbor geocells. Major event consumer 1911 can create a major event index (e.g., major event index) 1912. Major event consumer 1911 can configure major event filter 1902 in accordance with the major event index. Major event filter 1902 can reject other signals as commentary based on the configuration. For example, content from ingestion signals that matches event-specific ngrams but that does NOT match the event geo is filtered OUT as commentary (and stored in commentary 1903). That is, the region is essentially “locked” to the one or more geocells indicated in the major event index.

Human review 1906 can use validator 1904 to validate events. Major event detector 1907 can determine if an event is a major event (e.g., implementing functionality similar to major event classifier 1705). Major event detector 1907 can send all detected events to notification 1908 (e.g., similar to notification 1706). Major event detector can send major events to event signals 1909. Notification 1908 can notify entities of (major and other) events.

In other aspects, human reviewer 1906 is not present. Validator 1904 identifies/validates events using artificial intelligence and/or machine learning without human intervention.

Accordingly, using an intermittently deployable filter, such as, major event filter 1902, a “commentary zone” can be created outside a “locked” region. Signal content related to the major event in the “commentary zone” can be filtered out (e.g., as being of reduced relevance and/or limited relevance to the major event).

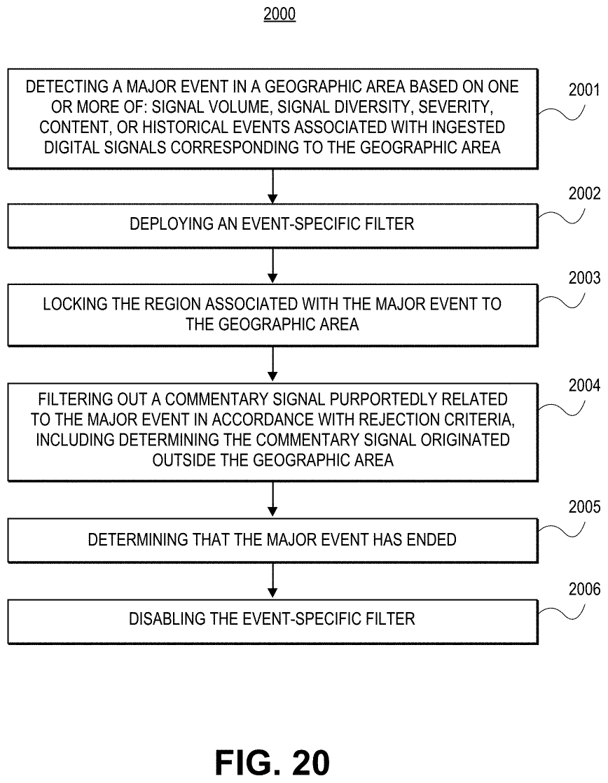

FIG. 20 illustrates a flow chart of an example method 2000 for filtering signals during major events. Method 2000 will be described with respect to the components and data of computer architecture 1900.

Initially, major event filter 1902 can be inactive and/or not configured, or otherwise undeployed into an event detection flow. As such, signals and signal sequences pass through and/or bypass major event filter 1902. For example, signal sequence 1921 can bypass (or pass through) major event filter 1902 to validator 1904. Based on input 1922 from human reviewer 1906 (or solely on artificial intelligence and/or machine learning), validator 1904 identifies/validates event 1923.

Method 2000 includes detecting a major event in a geographic area based on one or more of: signal volume, signal diversity, severity, content, or historical events associated with ingested digital signals corresponding to the geographic area (2001). For example, major event detector 1907 can detect event 1923 is a major event. Major event detector 1907 can detect event 1923 is a major event based on signal volume, signal diversity, severity, content etc. of signals included in signal sequence 1921. Major event detector 1907 can also detect event 1923 is a major event based on historical events associated with signals corresponding to a geographic area (e.g., one or more geo cells) associated with signal sequence 1921. Major event detector 1907 can also use any mechanisms described with respect to major event classifier 1705 to detect that event 1923 is a major event.

Major event detector 1907 can send event 1923 to notification 1908. Notification 1908 can notify relevant entities about event 1923.

Method 2000 incudes deploying an event-specific filter (2001). Method 2000 includes locking the region associated with the major event to the geographic area (e.g., the one or more geo cells)(2002). Major event detector 1907 can send event 1923 to event signals 1909. Major event consumer 1911 can access event 1923 from event signals 1909. Major event consumer 1911 can formulate major event index 1912 from event 1923. As depicted, major event index 1912 includes ngrams 1932, text 1933, and geo 1934. Text 1933 can be text in a signal (or one or more signals) included in signal sequence 1921. Ngrams 1932 can include on more ngrams derived from text 1933. Geo 1934 can include the one or more geocells defining a region associated with event 1923.

Major event consumer 1911 can deploy (activate) major event filter 1902 and configure major event filter 1902 in accordance with major event index 1912. Major event consumer 1911 can deploy/configure major event filter 1902 to filter out signals matching ngrams 1932 that are outside of a region defined by geo 1934. Thus, a region associated with event 1923 is essential “locked” to the region defined by the geocells in geo 1934.

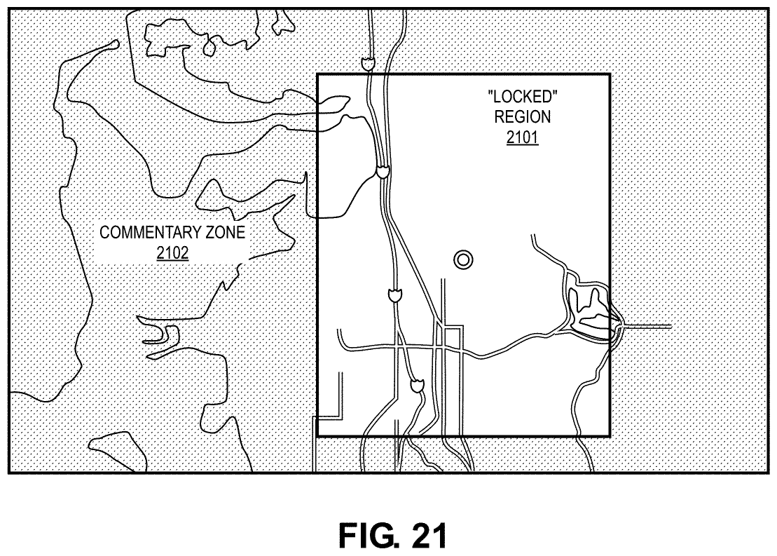

Turning briefly to FIG. 21, FIG. 21 illustrates a view of an example “locked” region 2101 and corresponding commentary zone 2102. “Locked” region 2101 may be defined by the one or more geocells in geo 1934. Commentary zone 2102 may be any area outside the “locked” region defined by the one or more geocells in geo 1934.

Method 2000 includes filtering out a commentary signal purportedly related to the major event in accordance with rejection criteria, including determining the commentary signal originated outside the geographic area (2004). For example, multisource module 1901 can send signal sequence 1924 to major event filter 1902. Major event filter 1902 can determine that signal sequence 1924 includes a signal 1926 purportedly related to event 1923. For example, major event filter 1902 can determine that signal 1926 includes content matching one or more of ngrams 1932. Major event filter 1902 can also determine that signal 1926 originated outside of the region defined by the one or more geo cells in geo 1934 (e.g., the signal originated in commentary zone 2102). As such, major event filter 1902 can filter out signal 1926 to commentary 1903.

Method 2000 includes determining that the major event has ended (2005). Method 2000 includes disabling the event-specific filter (2006). For example, based on updates to signal sequence 1921 and/or signals in one or more other signal sequences (e.g., within the region defined by the one or more geo cells in geo 1934), validator 1904 and/or major event detector 1907 can determine that event 1923 has ended. Major event detector 1907 can indicate the end of event 1923 in event signals 1909. Major event consumer 1911 can access the indication of event 1923 ending from event signals 1909.

In response, major event consumer can deactivate, disable, reconfigure, and/or otherwise undeploy major event filter 1902 from the event detection flow. As such, signals and signal sequences again pass through and/or bypass major event filter 1902.

Included are a number of examples of major event indices:

Five posts were collected from the Las Vegas Route 91 Festival shooting.

The ngrams extracted:
“Hell”, “route”, “mandalay”, “bay”, “hell shots”, “fired route”, “route % xnum %”, “% xnum % mandalay”, “mandalay bay”, “bay officers”, “officers everywhere”, “hell shots fired”, “shots fired route”, “fired route % xnum %”, “route % xnum % mandalay”, “% xnum % mandalay bay”, “mandalay bay officers”, “bay officers everywhere”

Typical ‘Shooting’ ngrams:
‘police’, ‘shot’, ‘shooting’, ‘traffic’, ‘cop’, ‘cops’, ‘officers’, ‘back’, ‘activity’, ‘right’, ‘ave’, ‘police activity’, ‘man’, ‘cars’, ‘officer’, ‘blocked’, ‘st’, ‘fired’, ‘shots’, ‘portland’, ‘traffic back’, ‘shots fired’, ‘stopped’, ‘suspect’, ‘stopped traffic’, ‘stopped traffic back’, ‘scene’, ‘say’, ‘get’, ‘chicago’, ‘lane’, ‘street’, ‘block’, ‘people’, ‘city’, ‘lanes’, ‘gun’, ‘protesters’, ‘% xnum % block’

Trippelet Score Examples
(These are shooting posts that are closely related as determined by trippelet model score to one specific Las Vegas shooting post, “What the hell, shots fired at route 91 by mandalay bay, officers everywhere”)

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

1. A method comprising:
detecting a major event in a geographic area based on one or more of: signal volume, signal diversity, severity, content, or historical events associated with ingested digital signals corresponding to the geographic area;
deploying an event-specific filter;
locking the region associated with the major event to the geographic area;
filtering out a commentary signal purportedly related to the major event in accordance with rejection criteria, including determining the commentary signal originated outside the geographic area;
determining that the major event has ended; and
disabling the event-specific filter.

2. The method of claim 1, wherein detecting a major event comprises detecting one of: a hurricane or a wildfire.

3. The method of claim 1, wherein detecting a major event comprises detecting an anomaly in one or more of: signal volume, signal diversity, severity, or content associated with ingested digital signals corresponding to the geographic area.

4. The method of claim 1, wherein detecting a major event comprises detecting a major event from a plurality of Time, Location, Context normalized signals.

5. The method of claim 1, wherein filtering out a commentary signal comprises filtering out a social media post.

6. The method of claim 1, wherein filtering out a commentary signal comprises:
extracting event specific n-grams from the commentary signal;
comparing the event specific n-grams to other n-grams from a random sample of other signals corresponding to a major event category;
determining that the specific n-grams match the other n-grams;
determining that the commentary signal does not match to the geographic area; and
filtering out the commentary signal based on the specific n-grams matching the other n-grams and the commentary signal not matching to the geographic area.

7. The method of claim 1, wherein filtering out a commentary signal comprises determining that the commentary signal originated in a commentary zone outside of the geographic area.

8. A computer system comprising:
a processor;
system memory coupled to the processor and storing instructions configured to cause the processor to:
detect a major event in a geographic area based on one or more of: signal volume, signal diversity, severity, content, or historical events associated with ingested digital signals corresponding to the geographic area;
deploy an event-specific filter;
lock the region associated with the major event to the geographic area;
filter out a commentary signal purportedly related to the major event in accordance with rejection criteria, including determining the commentary signal originated outside the geographic area;
determine that the major event has ended; and
disable the event-specific filter.

9. The computer system of claim 8, wherein instructions configured to detect a major event comprise instructions configured to detect one of: a hurricane or a wildfire.

10. The computer system of claim 8, wherein instructions configured to detect a major event comprise instructions configured to detect an anomaly in one or more of: signal volume, signal diversity, severity, or content associated with ingested digital signals corresponding to the geographic area.

11. The computer system of claim 8, wherein instructions configured to detect a major event comprise instructions configured to detect a major event from a plurality of Time, Location, Context normalized signals.

12. The computer system of claim 8, wherein instructions configured to filter out a commentary signal comprise instructions configured to filter out a social media post.

13. The computer system of claim 8, wherein instructions configured to filtering out a commentary signal comprise instructions configured to:
extract event specific n-grams from the commentary signal;
compare the event specific n-grams to other n-grams from a random sample of other signals corresponding to a major event category;
determine that the specific n-grams match the other n-grams;
determine that the commentary signal does not match to the geographic area; and
filter out the commentary signal based on the specific n-grams matching the other n-grams and the commentary signal not matching to the geographic area.

14. The computer system of claim 8, wherein instructions configured to filter out a commentary signal comprise instructions configured to determine that the commentary signal originated in a commentary zone outside of the geographic area.
